(19) United States
(12) Patent Application Publication
(10) Pub. No.: US 2026/0087527 A1
(43) Pub. Date: Mar. 26, 2026

(54) SYSTEMS AND METHODS FOR AUTOMATICALLY GENERATING AND PLACING SEMANTICALLY AND CONTEXTUALLY AWARE SUPPLEMENTAL CONTENT

(71) Applicant: ProrataAI, Inc., Pasadena, CA (US)

(72) Inventors: William Gross, Pasadena, CA (US); Tarek Najm, Bellevue, WA (US); Munirathnam Srikanth, Sammamish, WA (US); Ian Ferreira, Austin, TX (US); Nishant Dani, Redmond, WA (US)

(21) Appl. No.: 19/340,217

(22) Filed: Sep. 25, 2025

Related U.S. Application Data
(60) Provisional application No. 63/699,013, filed on Sep. 25, 2024.
(60) Provisional application No. 63/729,224, filed on Dec. 6, 2024.
(60) Provisional application No. 63/738,422, filed on Dec. 23, 2024.

(51) Int. Cl. G06Q 30/0241; G06F 40/40; G06Q 30/0251; G06Q 30/0273

(52) U.S. Cl. CPC G06Q 30/0276; G06F 40/40; G06Q 30/0269; G06Q 30/0275; G06Q 30/0277

(57) ABSTRACT

A method includes: providing identification information for a provider of supplemental content; retrieving information on the provider of supplemental content from the internet using the identification information to generate a content source profile; retrieving a user profile about a user; computing, with a user mindset prediction language model configured to determine a user's mindset while reviewing content, the user's mindset based on primary content presented to the user; selecting, by a supplemental source selection language model configured to select supplemental sources, the provider of supplemental content from a plurality of supplemental sources, based on the primary content; and generating in real-time, with a supplemental content generation language model configured to generate supplemental content, one or more pieces of supplemental content for the provider of supplemental content at one or more locations that are contextually consistent with the primary content.

### CROSS-REFERENCE TO RELATED APPLICATION(S)

This application claims the benefit of U.S. Provisional Patent Application No. 63/699,013 filed on Sep. 25, 2024, U.S. Provisional Patent Application No. 63/729,224, filed on Dec. 6, 2024, and U.S. Provisional Patent Application No. 63/738,422, filed on Dec. 23, 2024, the entire disclosures of which are incorporated by reference herein.

### BACKGROUND

A large language model is a type of machine learning model that uses vast amounts of text data to learn the statistical patterns of language, such as grammar, syntax, and vocabulary. By way of example, a large language model (LLM) may utilize neural networks and may be trained using unsupervised learning techniques. In some cases, supplying a sequence of words (represented as tokens or identifiers for semantic elements such as individual words, parts of words, and punctuation) to a trained large language model computes a prediction for each word in a vocabulary of words, where each prediction is a probability that the corresponding word will appear next in the sequence. As such, large language models can be trained to automatically generate text in response to user inputs. Large language models can also be trained to generate text in accordance with instructions (referred to as instruction tuning of a language model), provided as natural-language text, where these instructions may be referred to as prompts. Examples of LLMs include the Llama® models from Meta Platforms, Inc., the GPT® models from OpenAI Opco, LLC, the Claude® models from Anthropic, PBC, and the Mistral AI® models from Mistral AI, SAS. Accordingly, an instruction-tuned language model (e.g., large language model or small language model) can be configured to generate text in manners that are consistent with the instructions in the prompt, such as to automatically generate a report or summary of content supplied to the instruction tuned language model or to identify weaknesses in an argument in the supplied content.

Google® Ads and Google® AdSense® are the current state of the art for companies wishing to advertise themselves or their products on the internet and publishers wishing to earn income on their website. Google® AdSense® is an implementation of Google® Ads in which participating publishers provide advertisement spots on their website and get paid per click.

In Google® Ads, advertisers place bids to have their ads featured on websites, Google® searches, and YouTube®. Every time someone searches Google® or visits a site that displays ads, a near instantaneous auction automatically occurs to select the ad or ads that will be displayed and what their order will be. In order to compete in the auction, ads must reach minimum thresholds of quality and relevance, called ad rank thresholds. Eligible ads are then ranked to select the winning bid or bids. To determine the ranking of the eligible ads, Google® Ads considers bid price, ad quality, user signals and attributes, and the nature of the user's search.

Google Ads uses several factors in determining an ad rank:

Ad Quality: Quality is calculated by three components: the ad's expected click through rate, the relevance of the ad to the intent behind the user's search, and how relevant and useful the landing page is to the user who clicks the ad. The quality score is compared to all other ads that matched keywords or keyword phrases in the search query.

User signals and attributes: User attributes such as location and device type may be more appropriate for certain ads, resulting in higher ranking.

Nature of query: Google uses machine learning and natural language understanding technologies and models like BERT to better understand the intent behind search queries, and match them to the most relevant, best performing keywords. Ads with a greater relevance to the user's search intent will receive a higher ranking.

Bid price: Ranking is also influenced by the advertiser's bid price. Machine learning assisted “smart bidding” or fixed prices set by the advertiser determine the bid price. Higher bids will improve the ad's ranking position.

The above information disclosed in this Background section is only for enhancement of understanding of the present disclosure, and therefore it may contain information that does not form the prior art that is already known to a person of ordinary skill in the art.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is an example of a chatbot conversation in which a user has supplied an input query of “best way to spend a weekend in western Canada this summer,” where a trained large language model automatically generates a response that lists various national parks, outdoor activities, and historical sites that are available to visitors to western Canada and an embodiment of the present disclosure inserts supplemental content in the form of an advertisement in the response.

FIG. 2 is an example of a news article in which supplemental content in the form of an advertisement is generated and inserted into the news article in accordance with an embodiment of the present disclosure.

FIG. 3A and FIG. 3B illustrate examples in which a news article regarding an antitrust lawsuit against Apple® Inc. is interrupted by an advertisement, where in FIG. 3A, the advertisement relates to shoes, and in FIG. 3B, the advertisement is generated in accordance with an embodiment of the present disclosure and describes the recent launch of new products from Apple® and links to purchase those products.

FIG. 4 is a schematic block diagram depicting a process flow for registering a provider of supplemental content and generating supplemental content, according to one embodiment of the present disclosure.

FIG. 5 is a schematic block diagram depicting a process flow for placing supplemental content in the context of a web page, such as an article or chatbot response, according to one embodiment of the present disclosure.

FIG. 6 is a flowchart of a method for implementing a marketplace for generative advertisements, according to one embodiment of the present disclosure.

FIGS. 7A-7C illustrate an example of a chatbot advertisement inserted into a news article regarding electric vehicles, where the chatbot advertisement includes an interactive component for a user to ask questions or otherwise start a conversation with a chatbot regarding the advertised product, according to one embodiment of the present disclosure.

FIG. 8A is a flowchart of a method for generating and placing an advertisement in the context of a web page, such as an article or chatbot response, where an advertiser is selected from a plurality of advertisers based on the context of the web page, according to one embodiment of the present disclosure.

FIG. 8B is a flowchart of a method for generating and placing an advertisement in the context of a web page, such as an article or chatbot response, where an advertiser is selected from a plurality of advertisers based on the context of the web page, according to one embodiment of the present disclosure.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein.

Internet advertising generally seeks audience engagement, where viewers of ads click on ads that they are interested in, resulting in presenting the engaged viewer with more information about the products and services being offered, and providing user interfaces for the viewer to sign up for mailing lists, establish direct contact with sales representatives, purchase products and services immediately, and the like. A viewer's receptiveness to an advertisement frequently depends on a mental state of the viewer when encountering the advertisement. For example, in internet search advertising users may enter search queries that indicate interest in purchasing specific products (e.g., “What are the best basketball shoes on the market?”)—this inferred user intention indicates that the user is ready to make a purchase and specific targeted advertisements (e.g., basketball shoes) may be shown to the user along with other search results. On the other hand, irrelevant advertisements are expected to see less engagement (e.g., showing advertisements for stainless steel cookware in the response to the query about basketball shoes).

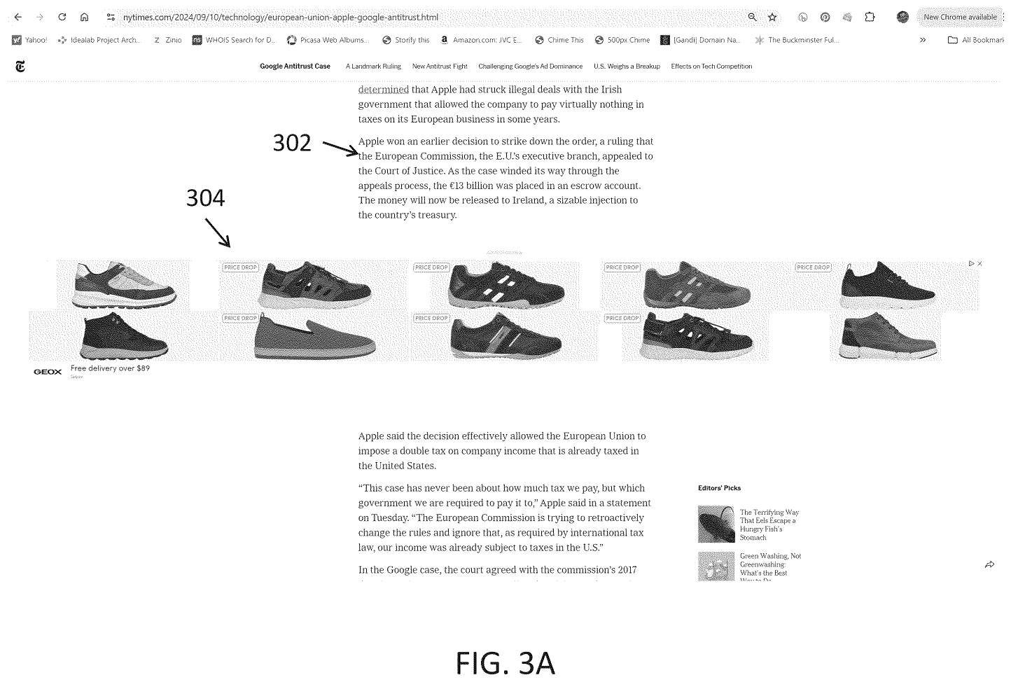

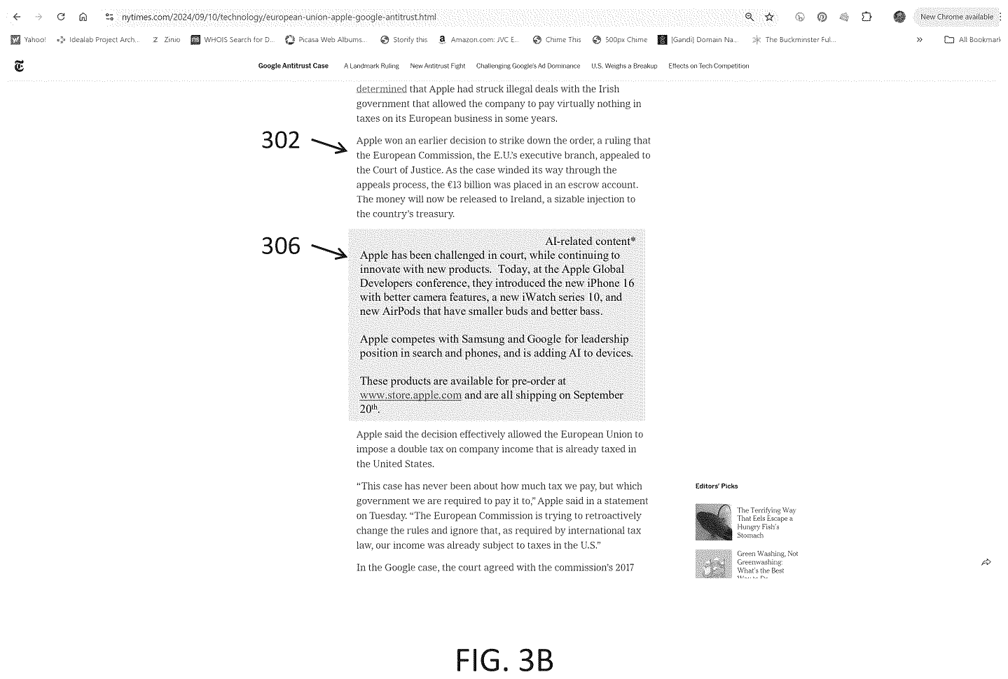

Advertisements may also be placed in-line or adjacent to other media. A news website or blog may show advertisements at the beginning and end of articles as well as in the middle of articles (e.g., between paragraphs of the article) and may also show advertisements in banners along the left and right sides of the text. As before, the effectiveness of these advertisements (e.g., click through rates, reflecting the rate at which users click on the ads) depends on the user's state of mind. A user reading an article reviewing the latest induction cooktops may be primed to click on an advertisement for stainless steel cookware (induction-compatible cookware) and less inclined to click on an advertisement for athletic jerseys. Such advertisements may also show up in random locations and circumstances. They are often poorly placed and formatted and appear jarring to the reader, thereby having the opposite impact from the one intended. The reader ignores the advertisement. One example of this type of advertisement is shown in FIG. 3A.

Advertisement retargeting refers to showing advertisements to users who previously expressed interest in particular topics, such as by visiting particular websites. For example, a user who visited a website for a particular shoe company may continue to see advertisements for that shoe company for several weeks in various other places on the internet (e.g., to encourage the user to visit the shoe company's website again and to complete a purchase). While such a retargeted advertisement may be more relevant than a randomly selected advertisement, the retargeted advertisement may be presented to a user in an inappropriate contextual content (e.g., an advertisement for new shoes in an article about excessive consumption). Or may continue to be presented to the user after the advertisement is no longer relevant (e.g., after the user has purchased a pair of shoes). Again these advertisements are poorly paced in the content and appear jarring to the user since they have little or no relationship to the contextual content. As a result, the reader ignores the advertisement, e.g. FIG. 3A.

As discussed above, Google's® ranking system is designed to serve ads with the highest relevance to the searcher's intentions which will yield the greatest click through rates. However, user forums are filled with frustrated advertisers claiming that their ads are being shown with irrelevant searches, leading to expensive ad clicks with no payoff. Additionally, website visitors are shown irrelevant ads which interrupt their reading experience and irritate them instead of matching them with useful products or services.

There is a need for artificial intelligence solutions to be used to create highly customized, contextual, generative supplemental content, including but not limited to advertisements, which are highly relevant to the user, yielding greater interaction, not only improving the user's experience but increasing revenues for publishers and advertisers. While advertisements are one example of customized, contextually-relevant supplemental content or supplemental information that can be generated in accordance with embodiments of the present disclosure, embodiments of the present disclosure are not limited thereto and include other types of supplemental content that is generated and placed within or alongside a given context, such as text articles, interactions (e.g., conversations) with chatbots, videos, audio streams, and the like. Such supplemental content or supplemental information may include: additional information about topics discussed in the given context (e.g., background explanations of stances of political parties in news article about recent developments); detailed explanations of concepts used in the given context (e.g., a brief explanation of the second law of thermodynamics in an article that mentions entropy); fact checking of statements made in the given context (e.g., citations to documents refuting common myths); and the like.

Natural language processing may be utilized to generate advertisements in real time based on the article's content (which may be referred to herein as primary content), style, the reader's mindset, and the advertiser's goals. This application of machine learning according to embodiments of the present disclosure creates supplemental content such as ads which flow naturally with the article and customizes the copy to the reader's interest, leading to greater engagement.

Aspects of embodiments of the present disclosure relate to systems and methods for automatically generating semantically and contextually aware supplemental content such as advertising that can also appear in placement locations of the primary content that have a relationship with the subject matter of supplemental content. Some embodiments of the present disclosure will be discussed below as applied to integrating supplemental content (such as advertisements) into the responses of chatbots and generating and inserting supplemental content that meshes with the content of articles. In some embodiments, the underlying implementations in the case of chatbots and in the case of articles are substantially similar. For example, FIG. 3B.

Considering the case of chatbots, large language models can be trained or tuned to respond to user inputs (e.g., generating text that is a semantic response to the user input, as if the user and the computer were conversation partners) rather than generating text that extends the user input (e.g., continuing the same thought in the same voice as the user). In some cases, users may present questions to LLMs, and the LLMs generate responses, where the content of the response may reflect the training data that was used to train the LLM or, where the chatbot is configured to perform retrieval augmented generation (RAG), the LLM may generate a response based on additional text (e.g., additional documents) that are supplied as part of an input to the LLM, such that the LLM generates its response based on this additional data.

Accordingly, some aspects of embodiments of the present disclosure relate to automatically generating supplemental content (e.g., advertisements) in the context of chatbot conversations, where the supplemental content (e.g., advertisements) are semantically and contextually relevant to the questions being asked by users.

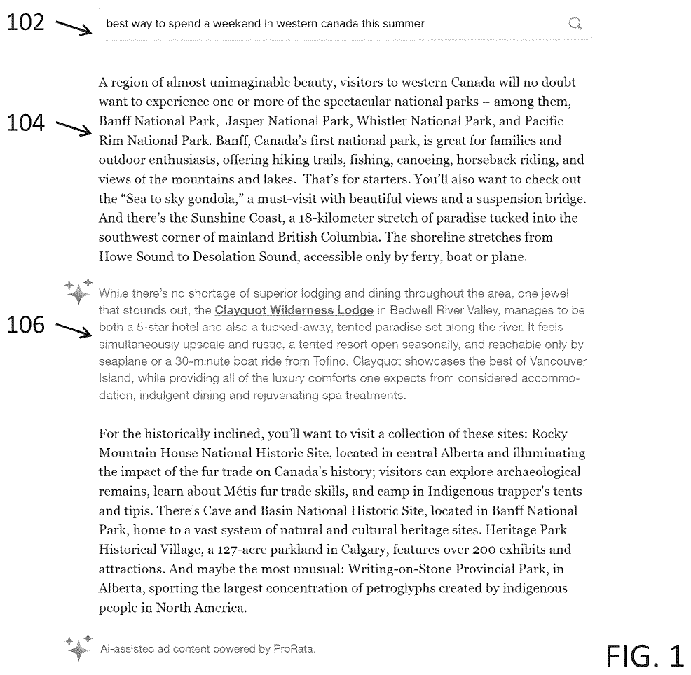

More specifically, FIG. 1 is an example of a chatbot conversation in which a user has supplied an input query 102 of “best way to spend a weekend in western Canada this summer,” where a trained large language model automatically generates a response 104 that lists various national parks, outdoor activities, and historical sites that are available to visitors to western Canada. In the example shown in FIG. 1, supplemental content in the form of an advertisement 106 is automatically generated and inserted in-line in the primary content, in this case the response 104 generated by the LLM. This example advertisement 106 promotes a hotel in western Canada and emphasizes aspects that track the flow, style, voice, of the content as well as the themes of outdoor activities and the natural wilderness that appear in the generated response 104.

Aspects of embodiments of the present disclosure relate to selecting supplemental content (e.g., an advertisement) to place in the chatbot response based on the semantic content of the user input (and, in some cases, the generated response) and based on the semantic meaning of the supplemental content (e.g., advertisement) to be placed, as will be described in more detail below.

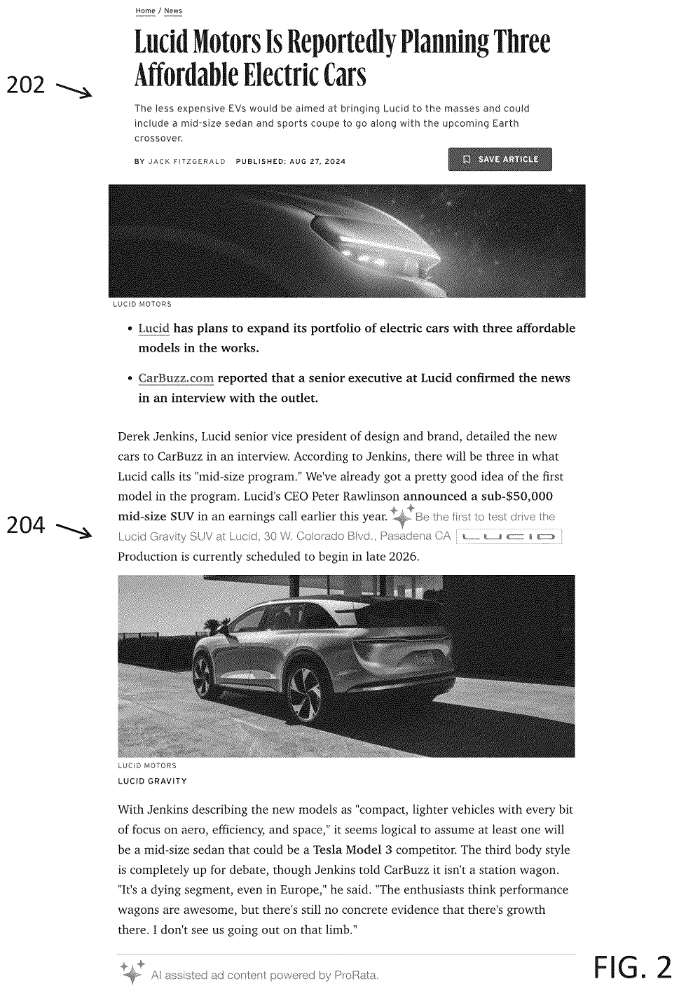

FIG. 2 is an example of a news article in which an advertisement is generated and inserted into primary content (here, a news article) in accordance with an embodiment of the present disclosure. The specific example of FIG. 2 relates to a news article 202 about new models to be produced by a manufacturer of electric vehicles. The same manufacturer may be an advertiser, who has requested that advertisements be placed in articles that describe the company with a positive sentiment (e.g., not placing the advertisements in articles that criticize the manufacturer). The manufacturer may further specify that the advertisements should direct users to the nearest showroom for the vehicles if the viewer is within some radius (e.g., 20 miles) of that showroom. In the case shown in FIG. 2, an embodiment of the present disclosure may detect that the visitor to the web page is located near Pasadena, California and generate and insert a customized advertisement 204 to inform the reader that they can test drive an electric vehicle at a showroom on Colorado Boulevard in Pasadena, California. While FIG. 2 shows one example where the supplemental content is an advertisement placed by the advertiser to direct users to the nearest showroom, embodiments of the present disclosure are not limited thereto. For example, the supplemental content or advertisement placed by the manufacturer may include responses to criticisms of the manufacturer's product in the article, thereby providing a counterpoint to the context of the article. Mechanisms for generating such supplemental content will be described in more detail below.

FIG. 3A and FIG. 3B illustrate examples in which a news article regarding an antitrust lawsuit against Apple® Inc. is interrupted by an advertisement, where in FIG. 3A, the advertisement relates to shoes, and in FIG. 3B, the advertisement is generated in accordance with an embodiment of the present disclosure and describes the recent launch of new products from Apple® and links to purchase those products. In more detail, an advertisement for shoes as shown in FIG. 3A has low relevance in an article 302 about the Apple® company, and therefore a reader is more likely to ignore the shoe advertisement 304 based on the context shift from electronics products to apparel. On the other hand, a user reading about the Apple® company may think of the products offered by that company and wonder if there are new models available—in such a case, the reader may be primed to purchase those products and an advertisement about those products 306 as shown in FIG. 3B may be more effective (e.g., have higher click through rates) than the shoe advertisement 304.

Various aspects of embodiments of systems and methods for generating and inserting supplemental content (e.g., advertisements such as those described above with respect to FIG. 1, FIG. 2, and FIG. 3B) will be described in more detail below, although embodiments of the present disclosure are not limited thereto.

Aspects of embodiments of the present disclosure may be implemented with one or more computer systems, where a computer system may include one or more processors and one or more computer-readable memories. The memories of the computer system store instructions that configure the computer system to implement special-purpose devices such that, when the instructions are executed by the one or more processors, the computer systems implement aspects of the embodiments of the present disclosure. As one example, the computer system may be a cloud-based computer system implementation, where the cloud-based computer system may include a hosted computing environment that includes a collection of physical computing resources that are remotely accessible, located at different facilities, and may be rapidly provisioned as needed. Certain data described herein may optionally be stored using a data store that may include a hosted storage environment that includes a collection of physical data storage devices that may be remotely accessible and may be rapidly provisioned as needed.

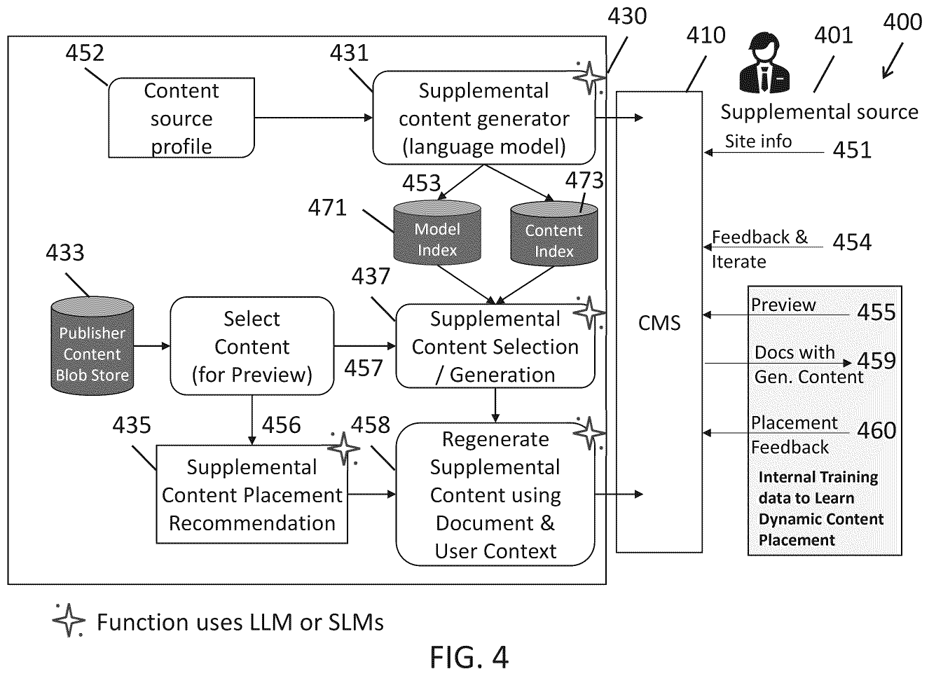

FIG. 4 is a schematic block diagram depicting a process 400 for registering a supplemental source 401 or provider of supplemental content (e.g., an advertiser, a collection of curated content, and the like), training a language model (e.g., large language model (LLM) or small language (SLM), etc.) and generating supplemental content or dynamic content (e.g., advertisements), according to one embodiment of the present disclosure.

In the embodiment shown in FIG. 4, the process 400 is implemented using a content management system (CMS) 410 and a supplemental content generation system 430. At 451, a supplemental source 401 (e.g., an advertiser) provides source content (e.g., a website and product information regarding products to be advertised or curated content to be inserted into other contexts) to the CMS 410, which are used to construct a content source profile 452 (e.g., an advertiser profile).

In some embodiments, a supplemental source model is computed from the content source profile 452 and stored in a model index 471. The supplemental source model reflects the style used by the content source, where the style may include word choice, discriminative terms (compared to competition), color palette and other visual design choices, and the like (e.g., input documents to generate the supplemental source model includes a brand style guide or similar guidelines for directing marketing messages).

In some embodiments, the supplemental source content is stored in a content index 473, which may be used as source material for generating supplemental content (e.g., a database of documents for retrieval augmented generation). For example, in the case of an electric vehicle company as a supplemental source (an advertiser), the supplemental source content may include web pages regarding the models of vehicles and information about specific models. Furthermore, in some embodiments, the source content is processed by a trained language model to extract specific statements (“claims”) made within the source content. Examples of such “claims” in the context of supplemental information about an electric vehicle may include operating range, passenger capacity, acceleration performance, maintenance requirements, pricing, specific terms and conditions of the warranty, and the like.

The content source profile 452 provides indications as to the supplemental content to be generated. In some embodiments, the supplemental source 401 is an advertiser or a content creator The supplemental source provides, at 451, detailed information about which products to promote (e.g., links to specific product pages on a website, uploaded documents of product descriptions, brand style guidelines, product research and reviews, multimodal content in the form of articles or books, insights/tips on certain topics or concept of interest, and the like), but embodiments of the present disclosure are not limited thereto. For example, in some embodiments, the advertiser may merely provide a company name and/or an internet address (uniform resource locator or URL) for a homepage. A web crawler program may then be used to retrieve web pages from the advertiser's website as input information for generating the advertiser profile (shown in FIG. 4 as content source profile 452). In some further embodiments, the web crawler program (or other subsystem of the advertisement generation system) performs searches on the internet (e.g., using a search engine) to retrieve articles regarding the company and/or products offered by the company to generate the advertiser profile. In some embodiments, the collected data is supplied to a large language model which is configured (e.g., prompted) to generate a summary of the content of the supplied web pages and other documentation. Additional data associated with the content source profile 452 will be described in more detail below in connection with aspects that make use of these data. Some or all of these approaches to the profile formation may be used together.

While aspects of embodiments are described above based on an advertiser as a supplemental source 401, embodiments of the present disclosure are not limited thereto. For example, the supplemental source 401 may be another content source (e.g., a fact checking source, one or more verified news publications, encyclopedias, and the like) that is provided at 451, and where the content source profile 452 reflects information about the supplemental source 401.

The content source profile 452 may be supplied to a supplemental content generator 431, which, in some embodiments, may be implemented using a supplemental content generation language model. For example, the supplemental content generation language model may be a large language model (e.g., from the Llama® family of LLMs) that is provided with a prompt that configures the supplemental content generation language model to generate supplemental content given an input context from the content source profile 452. For example, in cases where the supplemental content is to be advertisements, the prompt includes instructions that configure the supplemental content generation language model to generate advertising copy, and in cases where the supplemental content is to be fact checking information, the prompt includes instructions that configure the supplemental content generation language model to determine whether statements in the primary content are semantically consistent with facts (e.g., claims) made in the supplemental content and to generate copy that refutes the statements in the primary content based on the supplemental content. Embodiments of the present disclosure are not limited to supplemental content in the form of advertisements and fact checking and include generating supplemental content of other types by configuring the language model with a corresponding prompt (e.g., a prompt to explain scientific concepts appearing in the context, where the supplemental source 401 may provide scientific textbooks and references). In some embodiments, the prompt includes pairs of examples (few shot examples) of summarized content of websites and corresponding supplemental content. An SLM, small language model, fine-tuned, may be used as well, as explained below.

In some embodiments, the supplemental content generation language model is a trained language model that is fine-tuned (or retrained) based on training data to generate a corresponding type of supplemental content (e.g., the text of advertisements when generating contextual advertising copy, the text of fact corrections when generating fact checking supplemental content, and the like). In some embodiments, different language models are further fine-tuned or trained for specific supplemental sources 401 (e.g., specific advertisers, specific content sources, and the like). This fine tuning may be performed in a supervised manner based on training data collected from combinations of existing supplemental content (e.g., advertisements written by human experts, factual corrections written by human fact checkers, and the like) and source materials, such as the web pages of the advertisers corresponding to those advertisements (e.g., summaries of the web pages generated by an LLM, corresponding to data that would be stored in the advertiser profile or content source profile 452) that have previously shown to be successful or encyclopedia articles (e.g., web pages containing articles having relevant information to the supplemental content to be generated).

In some embodiments, several examples of generated supplemental content (e.g., ten advertisements) are generated based on the content source profile 452. In some embodiments, the examples of supplemental content are also generated based on an example or placeholder web page where the supplemental content would be placed or an example or placeholder response from a chatbot LLM. In some embodiments, multiple such example web pages and/or chatbot responses are considered. In some embodiments, the supplemental content generator (e.g., the supplemental content generation language model) is prompted to generate different examples that can vary in application. For example, in the context of advertisements, the supplemental content generator may be prompted to generate different types of advertisements, ranging from more general informational advertisements about the advertiser to advertisements promoting specific products, and other advertisements having more direct calls to action (e.g., test driving a vehicle or offering a trial subscription). These examples of generated supplemental content may be stored, at 453, in a database or index.

As an optional part of the process 400, the generated advertisements can be refined based on feedback from the supplemental source 401 (e.g., a marketing professional acting on behalf of the advertiser or an editor acting on behalf of a content source such as an encyclopedia). For example, the generated advertisements may be presented to the advertiser, and the supplemental source 401 may provide feedback regarding the examples at 454. For example, the generated advertisements may be shown in the example web page or in line with the example chatbot response. Such feedback may be used to further tune the models for later generating advertisements that are consistent with the advertiser's intent and purpose. Similarly, examples of generated supplemental informational content may be presented to an editor of a content source to confirm that the style, tone, and accuracy of the supplemental informational content matches the intent, purpose, and style of the content of the supplemental source 401.

In various embodiments, the feedback may be provided in a variety of ways for example, providing an approve/disapprove rating (e.g., thumbs up or thumbs down) for each advertisement, star ratings (e.g., 1 to 5 stars) for each advertisement, or a ranking or ordering of the supplemental content (e.g., advertisements). The feedback may be provided to the supplemental content generator 431 (e.g., as text presented as input to the supplemental content generation language model), and the supplemental content generator 431 may generate additional supplemental content (e.g., advertisements or revised advertisements) in response to the feedback. In some embodiments, the feedback is used as training data for further fine-tuning the supplemental content generation language model (e.g., to improve the quality of supplemental content generated in the future).

The input to the supplemental content generator 431 may also include data about the type of media the supplemental content to be generated will appear. Types of advertisements include mobile versus web advertisements, offline (e.g., print) versus online advertising, and transactional (e.g., direct call to action in purchasing products) versus informational (e.g., brand advertising, information about nearby physical retail locations, and the like). In various embodiments of the present disclosure, users may provide information about the requested types of advertisements to the supplemental content generator 431 through the CMS 410. The supplemental content generator 431 may also be trained to generate different supplemental content based on the medium of the context (e.g., the medium of the primary content), such as long-form blogging (or newsletters), microblogging, images, short-form video, long-form video, long-form audio (e.g., podcasts), and the like.

In some embodiments, the user feedback may also include advertisement type-based pricing, such as bid and ask thresholds with incremental distance-based pricing based on semantic contextual distance. For example, an advertiser who sells vacuum cleaners may be interested in placing advertisements in articles that relate to cleaning and housekeeping, and especially in web pages that specifically relate to vacuum cleaners. Because the advertisement is expected to be more effective (e.g., have higher click through rates) in web pages where the content is closely related than in web pages where the content is unrelated (e.g., a web page reviewing a video game) the advertiser may be willing to pay different prices in accordance with the relatedness of the web page, here these prices may be represented as bid and ask thresholds, assuming an online advertising auction for advertising slots on a web page. In some embodiments, a language model is configured (e.g., prompted or trained) to automatically compute incremental distance scores for contextually relevant advertisements (e.g., cosine distance scores or contextual match scores) between the content and the advertisement (e.g., values from 0 to 1 or 100%, where a contextual match having a value of 1 indicates high relevance of the advertisement to the content and a contextual match a value of 0 indicates no relevance of the advertisement to the content).

In some embodiments, the semantic contextual distance is computed based on computing vector embeddings of the context (e.g., the content of a web page) and the advertisement using a large language model (e.g., a semantic contextual distance language model configured and/or trained to compute a semantic contextual distance between two pieces of content), such as by extracting the activations (e.g., outputs) of a layer of a deep neural network implementing the large language model. The embeddings in some embodiments are based on the kind of information captured from content, and the distance measures between the embeddings represent probability functions that are like weighted combinations of different comparison functions that result in a score between 0 and 1. In some embodiments, the vector embeddings are learned (e.g., a language model is trained to compute the vector embeddings) from explicitly marking up concepts such as entities and relationships between those entities in text and projecting the patters in a vector space to specific multi-dimensional vector embeddings (e.g., as the labels of the data). In some embodiments, the semantics of concepts like entities, relationships, events, and the like are extracted from text and represented with one or more embeddings (note that each embedding will have a different distance measure). In some embodiments, distances are computed based on the type of information compared with their embeddings being the proxy and the actual functions used to compare them. In some embodiments, distance metrics other than cosine distance are applied, based on the type of entity. For example, while some representations, e.g., chunks from content and entities, are compared based on a cosine distance measure, other representations such as relationships may have a weighted combination of a linear distance between the vectors representing the entities in the relationship, and the embedding for the relationship itself.

Accordingly, the advertisement CMS 410 may present the proposed advertisements and an advertiser may supply the bid and ask thresholds that they would be willing to pay to place the advertisement at different incremental distances (e.g., distances of 0, 0.5, and 1). For example, the advertisements may be shown as being placed within different web pages relating to different topics (e.g., a news article about an upcoming election, a blog post with housekeeping advice, and a review of an electric vehicle) having different incremental contextual distances (as discussed above) from the advertisement. In various embodiments, the bid price may be provided by the advertiser in the form of a cpc (cost per click) or cpm (cost per 1,000 impressions) or cpa (cost per action, such as “I would by $50 for a visit to the showroom”) or other monetary ranking of how valuable each ad would be.

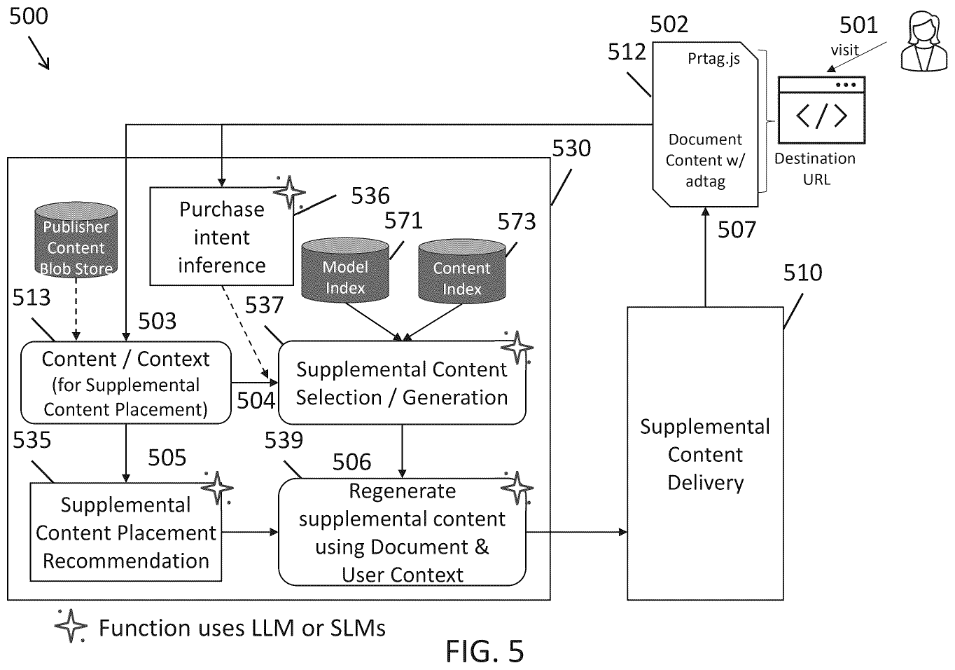

In some embodiments, the feedback regarding prices that the user is willing to pay for a given advertisement at different incremental distances from the content of a web page is used to control a process for automatically bidding on placing an advertisement on that web page, as will be described in more detail below with respect to FIG. 5.

Still referring to FIG. 4, some aspects of the present disclosure relate to learning preferences for dynamic placement of supplemental content.

As noted above, in some cases the generated supplemental content (e.g., generated advertisements) are shown in the context of an example document. The example document may be selected at 455 from a collection of static examples (such as the publisher content blob store 433), from live examples crawled on the internet, or generated live from a chatbot.

In some embodiments, publishers of content may impose constraints or guardrails on where an advertisement or other supplemental content can be shown within a document (e.g., within the primary content). For example, there may be designated slots for supplemental content between specific paragraphs of a web page and/or in sidebars on the web page. In some circumstances, there is only a single available slot. However, in other cases, a publisher may provide multiple possible slots for supplemental content or may allow advertisements supplemental content to be integrated anywhere within a body text of the web page. At 456, a supplemental content placement recommendation component 435 generates a recommendation as to where to place generated supplemental content within an article. In some embodiments, the recommendation is computed using a contextual placement language model (e.g., a large language model or a small language model) that is prompted or instructed to identify recommended locations to insert generated supplemental content (e.g., an advertisement). The contextual placement language model may be trained or fine-tuned to generate recommendations as to where to insert an advertisement based on training data, where the training data includes examples of advertisements placed at different locations within web pages and corresponding metrics of advertising effectiveness (e.g., click through rates) collected through web analytics.

In addition, at 457 a supplemental content selection and generation component 437 selects supplemental content to include in the example web page from among the supplemental content that were generated by the supplemental content generator 431. For example, the supplemental content selection and generation component 437 may select an advertisement from a plurality of advertisements that were generated by the supplemental content generator 431. Different types of advertisements (e.g., product versus informative) may be more appropriate in different types of web pages. For example, an advertiser may prefer an informational advertisement in a news article describing various companies that include the advertiser. On the other hand, the same advertiser may prefer an advertisement regarding a specific product in an article that describes how to deal with a household problem solved by that product. In circumstances where the document provides multiple slots to place advertisements and where there are multiple advertisements available, each advertisement may be considered for each of the slots (e.g., using a model trained based on effectiveness of other advertisements in various web pages).

At 458, a supplemental content regeneration component 438 re-generates the selected supplemental content based on the primary content or document (the web page, content or chatbot) and the user context. As noted above, the example supplemental content generated by the supplemental content generator 431 provides a range of different types of possible generated supplemental content consistent with the supplemental source 401 without context of some specific primary content (e.g., generated in a placeholder example web page or in a placeholder chatbot responses). In some embodiments a supplemental content regeneration language model is configured to rewrite or regenerate the supplemental content (e.g., an advertisement) to match the style and tone of the primary content or document in which the supplemental content will be placed. As noted above, the supplemental content generator 431 may generate a variety of supplemental content (e.g., in the case of advertisements, brand advertisements, advertisements for each product in a line of products, and the like for a given advertiser). However, different chatbots and different web pages may be written in different styles (e.g., an authoritative style for newspaper articles, a familiar style in blog posts, a casual style in articles focused on entertainment, and the like) and therefore the advertisements are rewritten to match the style and tone of the primary content in which they are placed to avoid breaking the flow (e.g., to avoid sudden tonal shifts between the main content or primary content of the document and the supplemental content). In addition, the supplemental content (e.g., advertisements) can be regenerated based on a user profile or context, such as a user's browsing history, location, known interests, and such that would be available through existing advertising tracking data. In a preparatory stage, various example user profiles may be used to customize the user context so that the tone, voice, or flow of the supplemental content (e.g., advertisement) are matched to the user.

Optionally, in some embodiments the resulting example advertisements are presented, at 459, to the advertiser, and the advertiser may provide additional placement feedback at 460. In various embodiments, the feedback may be provided as prices that the advertiser is willing to pay for a given location placement of a given advertisement in a document, a ranking of placements of an advertisement in a document, a ranking of the different advertisements shown in the document, and the like. For example, at the end of an article, or in a sidebar, or in a paragraph that may have a close contextual relationship with the advertisement. In some embodiments, the placement feedback is provided as training data for fine-tuning a language model (and/or providing additional examples in the prompt for the language model) implemented as part of the supplemental content placement recommendation component 435.

Having registered a supplemental source 401 (e.g., an advertiser) and trained the models of the supplemental content generation system 430, some aspects of embodiments of the present disclosure relate to generating supplemental content (e.g., advertisements) through inference during runtime.

FIG. 5 is a schematic block diagram depicting a process 500 for placing supplemental content (e.g., advertisements) in the context of primary content on a web page 512, such as an article or chatbot response, according to one embodiment of the present disclosure. In the example of FIG. 5, a supplemental content delivery server 510 supports the delivery of supplemental content to web pages. At 501, a user visits a web page at a destination URL. At 502, a script (identified in FIG. 5 as Prtag.js) embedded in the web page is executed to begin the process of delivering supplemental content for the web page. At 503, the content of the web page (e.g., the primary content) visited by the user at 501 is delivered to a supplemental content generation system 530 as content/context 513.

In some embodiments where the supplemental content is an advertisement, for each document that the system is looking to place an advertisement in (e.g., for a web page or for each query the user types in that is supplied to a chatbot), a purchase intent inference component 536 of the supplemental content generation system computes an inferred purchase intent score or purchase intent level, which may be a number between 0% and 100%. In some embodiments, the inferred purchase intent score is computed by configuring (e.g., prompting) a language model to compute such a score (e.g., a prompt such as “Given a user visiting a web page with the following page context, what is the probability that the user intends to make a purchase? Here is the page context: {page_context}” or, in the case of a chatbot interaction, a prompt such as “Given a chat context of a chatbot conversation between a user and a chatbot, what is the probability that the user intends to make a purchase? Here is the chat context: {chat_context}”). For example, the query “basketball shoes” might have a purchase intent score of 33%, whereas the query “store that sells basketball shoes” might be 66%, or the query “where can I buy the Michael Jordan 2005 commemorative shoe” would have a 95% purchase intent score. Similarly, articles or other web pages can be automatically analyzed by a language model to compute a purchase probability score (e.g., where product review articles may have a higher purchase intent score than articles about national politics). In some embodiments, the purchase intent score and the dollar value estimate of a click through may be used in setting the bid or advertising price. As such, some aspects of embodiments of the present disclosure relate to a large language model that is trained or fine-tuned on examples of purchase intent to compute purchase intent scores (e.g., based on measured click through rates and/or conversion rates on advertisements placed on similar web pages), which may be used to predict value of an advertisement for each document (e.g., chatbot response or web page). In some embodiments, the language model is configured or prompted to compute a category of the inferred purchase intent. In some embodiments, the categories of inferred purchase intent includes: no purchase intent; browsing; researching; final selection; and ready to buy.

In a manner like that discussed above, at 504 the supplemental content selection and generation component 537 may generate supplemental content from scratch by prompting the trained language models or alternatively the system 530 may select supplemental content from a collection of supplemental content (e.g., pre-generated advertisements from multiple advertisers, pre-generated supplemental messages from different news sources, and the like). In some embodiments, the supplemental content selection and generation component 537 uses a supplemental content model from the model index 571 to generate the supplemental content in accordance with the style of the content source and to populate the supplemental content with information taken from the content index 573 (e.g., product literature regarding products to be advertised, information from articles stored in the content index, and the like). In some embodiments the supplemental content are automatically screened based using a language model on selecting highest similarity to the primary content of the web page 502 (e.g., based on using the language model to compute semantic contextual distance discussed above, and filtering out pieces of supplemental content that are semantically distant from the context). In some embodiments where the supplemental content is an advertisement, there may be a set of different advertisements from the same advertiser but with different goals, or there can be advertisements from different advertisers with different goals. As such, in some embodiments, the contextual distance is used to perform a goal match between the document (the web page) and the best supplemental content (e.g., best advertisement and/or advertiser) for the context (e.g., chatbot interaction or article on a web page).

As noted above, the contextual distance may be a measure of how close the objective of the surrounding content is to the goal of the advertisement and may be represented as a number between 0% and 100%. In some embodiments, the pieces of supplemental content (e.g., advertisements) are then ranked based on how close they are to the content, and the closest piece of supplemental content (e.g., advertisement) is selected. In some embodiments, the price that the supplier of the supplemental content (e.g., advertiser) is willing to pay may depend on the contextual distance between the supplemental content and the primary content of the web page 512. Therefore, in some embodiments, the amount that is charged or offered to the supplier of the supplemental content for placing that supplemental content depends on the contextual distance, where the relationship between the contextual distance and the price may be linear or another curve (e.g., quadratic).

In some embodiments, the CMS 410/supplemental content delivery server 510 further provides interfaces (e.g., user interfaces and/or application programming interfaces) for editorial controls to improve brand safety in the placement of advertisements by identifying brand rules and style guidelines. In some circumstances, these rules and style may be provided from the source of the supplemental content, (e.g., in the case of advertisements, available from the advertiser's website, explicitly supplied by an advertiser, or inferred from prior advertising campaign information of the advertiser). For example, advertisers may want to avoid having their advertisements placed in connection with specific topics (e.g., politically charged subject matter, violent films and television programs, and the like) and topics that are contrary to the values of the brand. Other types of supplemental content sources (e.g., fact checking services) may limit whether they present supplemental content based on whether the supplemental content would be redundant based on the primary content (e.g., merely repeating information already present in the primary content) or based on whether the supplemental content is likely to have an impact on the reader (e.g., where the primary content takes an extreme viewpoint). As such, the supplemental content selection and generation component 537 may further remove or filter out supplemental content that are mismatched with the content of the document.

In some embodiments, the primary content of the document is determined by supplying the document to a language model that is prompted or trained (e.g., fine-tuned) to detect the context and semantics of a document. More specifically, in some embodiments, an “advertising language model” (ALM) or brand language model is trained to determine which contexts are relevant would improve the reputation of the brand (e.g., help the brand rather than hurt the brand) and to detect documents that may present brand safety concerns —where contextual analysis from the LLM controls favorability to place an advertisement within a specific context. The advertiser is an example of a content creator of supplemental content, where advertising corresponds to supplemental content provided by the content creator, and brand reputation corresponds to the reputation of the content creator—as such, the brand language model may also be termed a reputation language model that is trained to determine contexts are relevant would improve the reputation of the brand, whether the brand is an advertiser or other provider or creator of supplemental content.

More specifically, by obtaining a contextual understanding of the content into which supplemental content is to be placed, the supplemental content generation system 530 can allow the supplier of the supplemental content (e.g., an advertiser) to control when its supplemental content show up (e.g., no wars, no extremism, no climate change denial, etc. in association with advertisements) as well as automatically generate an audit trail for the types of content where the supplemental content did show up.

In some embodiments, the inferred purchase intent score is provided to the supplemental content selection/generation component 537 as a factor in determining a type of supplemental content to be selected or generated and placed into the context of the web page 512. For example, a high inferred purchase intent score may be a factor in the generation or selection of advertisements directed to specific products, a moderate purchase intent score may be a factor in the generation or selection of brand advertisements, and a low purchase intent score may be a factor in generating or selecting informational supplemental content.

The supplemental content placement recommendation component 535 generates, at 505, a recommended location within the document (e.g., the content/context) to show the supplemental content, such as the advertisement (e.g., among the locations permitted by the publisher of the content on the web page 512).

In some embodiments, the supplemental content placement recommendation component 535 uses a language model to generate the placement recommendations and the language model may be prompted or retrained based on supplemental source 401 bidding and offers for placement within the web page 512, such that the predictions made by the advertisement placement recommendation component 535 more closely match the preferences of the supplemental sources. In some embodiments, the advertisement placement recommendation 535 is trained based on the measured performance of other supplemental content (e.g., click through rates of advertisements).

The selected supplemental content and the selected placement within the document (e.g., the web page 512) are supplied to a supplemental content generation component 539 to regenerate, at 506, the selected supplemental content to match the style and tone of the primary content (e.g., the document on the web page 512) and based on the user context. In some embodiments, the regeneration of the advertisement (e.g., style transfer) is implemented using a language model that is fine-tuned or retrained based on historical advertising copy and based on feedback on the performance of the advertisements that are inserted into live documents (e.g., other web pages served to users).

In some embodiments of the present disclosure, the content of the supplemental content is displayed within the document in a progressive or streaming manner, such as by being incrementally shown character-by-character or word-by-word (e.g., animated) from beginning to end. In various embodiments, the streaming or animated display of the supplemental content (e.g., advertisement) is implemented using a script (e.g., JavaScript code) or using cascading style sheets (CSS). In some embodiments, the incremental display of the supplemental content corresponds to the real-time generation (or regeneration) of the supplemental content based on the context of the advertisement (e.g., words are shown as each token is generated by the LLM, such as the supplemental content generation component 539). In some embodiments, a case where the supplemental was previously generated, the supplemental content may still be streamed and shown incrementally within the web page 512 to give the impression or illusion that the supplemental content is being generated, live, for the user. In some embodiments, the streaming of the supplemental content is performed when the document is loaded (e.g., during loading of the web page) and in some embodiments the streaming of the supplemental content is performed once the location in the document at which the supplemental content was placed becomes is visible (e.g., the incremental display of the supplemental content begins when the user has scrolled the document such that the location reserved for the supplemental content is visible). In some embodiments, a blank area is reserved for the supplemental content (e.g., a <div> element having a specified size, in the case of a web page), where the supplemental content is incrementally displayed within the blank area (e.g., to fill the blank area with the text of the supplemental content). In some embodiments, the supplemental content is inserted in-line with the other content of the document, such that other content of the document shifts as the supplemental content is incrementally displayed (e.g., each new line of the supplemental content causes following paragraphs and/or images of the document to be shifted farther down in the web page).

While some aspects of embodiments of the present disclosure are described in the context of generating text supplemental content, embodiments of the present disclosure are not limited thereto and also include generating other types of media such as images, audio (e.g., speech and/or music), and video (e.g., animations, or multiple frames of images, which may be synchronized with corresponding audio). The supplemental content may be multi-modal, such as text accompanied by an image (e.g., text overlaid on an image or adjacent to an image), audio synchronized with moving images, narrated speech in a video (e.g., generated text fed through a text-to-speech converter), and the like. Images, audio, video, and the like may be synthesized in various embodiments of the present disclosure based on trained generator networks (e.g., text-to-image models such as DALL-E or Stable Diffusion, text-to-video models such as Sora, and the like).

Because generating supplemental content using language models is relatively slow compared to the usual pace of online advertising auctions (e.g., where the auctions are completed in a fraction of a second), in some embodiments of the present disclosure, the process of generating supplemental content may be performed offline. For example, the supplemental content delivery system 510 may bid on a slot with a low bid to get a location (e.g., URL) of the page and to process the page and generate supplemental content (e.g., an advertisement or multiple advertisements) for the page for one or more supplemental sources 401 (e.g., advertisers). During a subsequent auction relating to the same web page and a similar user context, the supplemental content delivery system 510 makes a bid in accordance with the supplemental source's preferences and, if it wins the auction, delivers the pre-generated supplemental content to the web page 512.

While various examples of embodiments of the present disclosure are described above primarily in the context of web pages, embodiments of the present disclosure are not limited thereto. For example, as shown in FIG. 1, advertisements may be inserted into the generated responses of chatbots (e.g., chatbots implemented using language models), whether the responses of the chatbots are delivered through a web page rendered by a web browser or another user interface (e.g., a stand-alone application or app, integrated into an operating system of a computing device such as a smartphone, a smart appliance with voice and/or display interfaces, and the like). In such cases, similar processes to those described above with respect to FIG. 4 and FIG. 5 may be applied to the text responses generated by chatbots, where appropriate supplemental content (e.g., advertisements) are selected based on the content of the chatbot responses, then rewritten or regenerated based on the content of the document and the user context such that the supplemental content matches the style of the generated chatbot response.

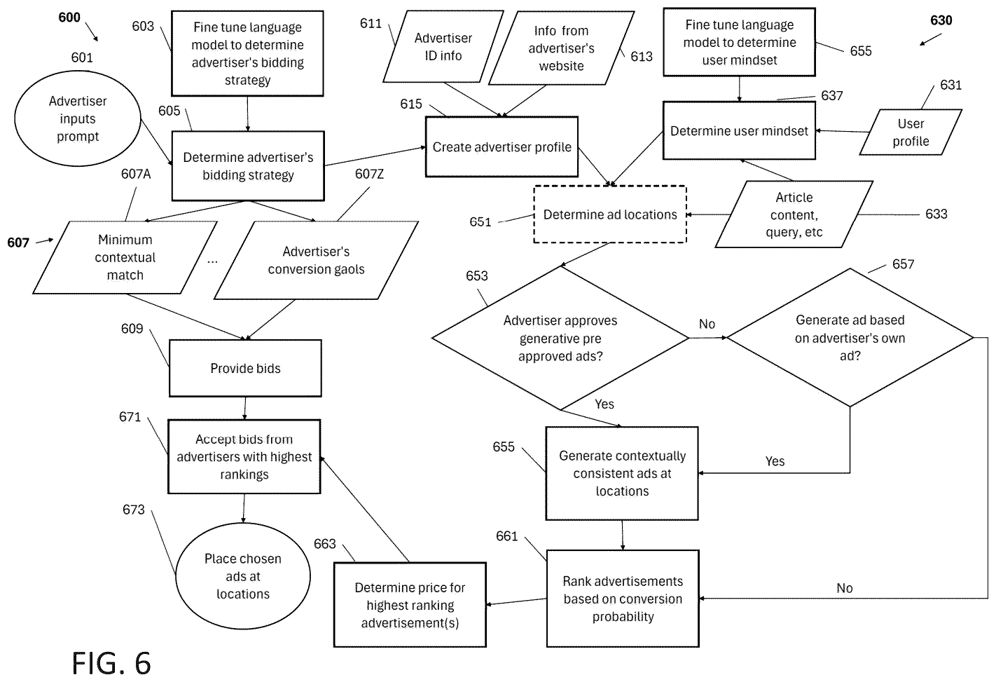

FIG. 6 is a flowchart of a method 600 for implementing a marketplace for generative advertisements, according to one embodiment of the present disclosure. The method 600 may be implemented by a generative advertisement placement system implemented by a computer system including one or more processors and memory storing instructions that, when executed by the one or more processors, implement the method 600.

As described above, a viewer's (or user's) receptiveness to an advertisement depends on the mental state of the viewer when encountering the advertisement. Aspects of embodiments of the present disclosure were described above in which supplemental content (e.g., advertisements) are selected and generated to match a context in which they are placed, such as the subject matter and tone of an article or answer from a chatbot, because a viewer's mindset may be swayed by the content that is presented to the viewer.

Some aspects of embodiments of the present disclosure relate to generating advertisements based on the content of the web page shown to the viewer (the primary content) along with other information known about the viewer. This additional information may include, for example, demographics (e.g., estimated income range), age (e.g., age group), sex, education, interests, prior search history (e.g., as indicative of interests), geographic location, and the like. which may collectively be referred to as a user profile or viewer profile.

Similarly, an advertiser may have a marketing strategy relating to the types of users or consumers they want to reach, the price that the advertiser is willing to pay to reach such users or consumers (where the price may vary based the user profile of the viewer) in accordance with context (e.g., willingness to pay more to place advertisements in documents that are favorably related to the products being advertised) and to the viewer's receptiveness (e.g., willingness to pay more when the viewer is receptive to making a purchase). In some embodiments, an advertiser may provide a written explanation of their marketing strategy or bidding strategy 601 for bidding on advertisements to be placed within content. This written bidding strategy 601 may include plain text, tables, and the like. In some embodiments, the advertiser may decide on this bidding strategy 601 based on the examples of advertisement placements presented to the advertiser as described above with respect to FIG. 4.

The system may include a language model that is fine-tuned at 603 to determine an advertiser's bidding strategy based on the written explanation of that bidding strategy 601 (e.g., the bidding strategy may include text, speech, and/or speech transcribed into text). In more detail, the fine-tuned language model may be trained or fine-tuned and/or prompted to take the written explanation of the bidding strategy 601 as input at 605 and compute a plurality of explicit conditions and goals 607 (shown in FIG. 6 as conditions and goals 607A through 607Z). In some embodiments, a bidding strategy language model extracts explicit goals 607 of the supplemental content creator from the written explanation of the bidding strategy 601 (e.g., where some goals may be implied in the written description). The defined explicit goals 607 are then used to automatically identify what supplemental content to promote, where to promote such content (e.g., what primary content to insert the supplemental content into), how much to spend at any point of time for that promotion to ensure the budgets are effectively utilized, as discussed in more detail below to implement goal-based content promotion or advertising. Here, the bidding strategy is tied to the goal that the advertiser or content creator (supplemental content provider) wants to achieve, as expressed in the bidding strategy 601.

In some embodiments, the explicit conditions and goals 607 include textual instructions that are provided to a language model (which may also be fine-tuned) together with information about the context in which an advertisement will be placed (e.g., a web page or an output of a chatbot) to generate bids for placing an advertisement at 609, thereby configuring the language model to act as an automated agent implementing the specified bidding strategy (e.g., a bidding agent language model).

In some embodiments, the explicit conditions and goals 607 include executable computer code, e.g., where the fine-tuned language model outputs source code that may be executed, interpreted, or compiled to implement the conditions and goals 607 extracted from the bidding strategy 601 and to generate bids for placing an advertisement at 609. In some embodiments, the fine-tuned language model outputs parameters or arguments that are supplied as inputs to existing computer code (e.g., as arguments to an existing function to compute a factor for computing a bid).

In some embodiments, different explicit conditions and goals 607 may be evaluated by different language models or different explicit source code. For example, computing a minimum context match 607A (e.g., a threshold minimum contextual match) may be performed using a language model, whereas the advertiser's conversion goal 607Z may be expressed as an explicit expression (e.g., an inequality such as conversion >20%). While FIG. 6 shows two different conditions or goals 607A and 607Z, embodiments of the present disclosure are not limited thereto, and additional conditions and goals 607 may be extracted at 605 from the input prompt in accordance with the number of conditions and goals 607 may vary depending on the number of conditions and goals expressed in the written explanation of marketing strategy or bidding strategy 601 received from the advertiser, as indicated by the ellipses. Accordingly, the automated agent implementing the specified bidding strategy may use a combination of executing explicit computer code and/or processing text through language models to automatically generate a bid at 609 on behalf of an advertiser.

Referring back to 605, the advertiser's bidding strategy as determined at 605 may be combined with other information about advertiser, such as a unique identifier or advertiser identification information 611 regarding the advertiser (e.g., a URL associated with the advertiser, a unique number such as a tax identification number, or a unique number assigned by the generative advertising system), and product and advertiser information 613 scraped from publicly available resources regarding the advertiser, such as information scraped or retrieved from one or more of the advertiser's websites, reviews, products, services, customers, or competition (e.g., text and images). In some embodiments, this product and advertiser information 613 includes the information retrieved at 451, as described above with respect to FIG. 4.

The advertiser's bidding strategy, the identification information 611, and the information 613 are combined to create an advertiser profile at 615. In some embodiments, the advertiser profile is a concatenation of the advertiser's bidding strategy (e.g., as extracted by a language model at 605, which may be represented as the conditions and rules 607), the identification information 611, and the information 613. In some embodiments, the advertiser's bidding strategy, the identification information 611, and the information 613 are provided to a language model that is prompted to generate a condensed or compressed representation of the input data to create the advertiser profile 615.

As noted above, aspects of the method 600 relate to determining or predicting a user mindset, as shown at 630. A viewer profile or user profile 631 may include, for example, demographics (e.g., estimated income range), age (e.g., age group), sex, education, interests, prior search history (e.g., as indicative of interests), geographic location, and the like. The user mindset may also be reflected and/or influenced by the primary content 633 being presented to the user, such as content of the article being displayed, generated content from a language model in response to a query, and/or the query presented by the user to the model (or the query searched by a user to reach an article). Examples of content include, but are not limited to, a web page of a website, a chatbot interaction (e.g., transcript of a chat interaction), an application (e.g., a mobile game or other app), a video (e.g., a pre-roll or mid-roll advertisement in online video content), and a piece of audio (e.g., inserted into a podcast, radio program, or music).

The user profile 631 and the primary content 633 are supplied to a user mindset prediction language model that is configured (e.g., prompted) and/or fine-tuned at 635 to determine a user mindset based on a given user profile 631 and primary content 633. In some aspects of embodiments, the user mindset includes a computed purchase intent (e.g., a value from 0 to 1) indicating a likelihood that a user is ready to purchase a product or service that may be connected to the primary content 633 (as discussed above with respect to the purchase intent inference component 536 in FIG. 5).

In the case of contextually generating advertisements to be inserted into a chat interaction with a chatbot, the primary content 633 includes a chat history including user inputs, and accordingly the user mindset and/or user purchase intent is further determined at 637 based on the chat interactions.

In some embodiments, the fine-tuning of the language model is performed based on training data 635 that includes user profiles 631 and primary content 633 shown to users with various types of advertisements, along with labels in the form of whether the user clicked on the advertisement (e.g., click through rates) and whether the user purchased a product (e.g., conversion rates).

As described above in reference to 435 of FIGS. 4 and 535 of FIG. 5, in some cases a web page or output of a chatbot may specify a plurality of locations within the content where an advertisement can be inserted. In such cases, the user mindset determined at 637 and the advertiser profile created at 615 are used to select from among those possible locations at 651 to choose the most effective location that would influence or sway a user or viewer. In some embodiments, a language model is fine-tuned and/or prompted to select or rank the various possible advertisement locations in the content 633 (e.g., which paragraphs the advertisement should be inserted between) to maximize the click-through rate and/or conversion rate of an advertisement from that advertiser. In other cases, there may only be a single location allocated for the advertisement, in which case a location for the advertisement does not need to be determined at 651 and the process can proceed directly to 653.

At 653, if the advertiser has previously approved the example generated advertisements (e.g., as presented in the method 400), then contextually consistent advertisements are generated at locations at 655 in accordance with techniques described above with respect to FIG. 4 and FIG. 5 consistent with the pre-approved advertisements and tailored for the context of the content and the user profile. In some embodiments, the language model for generating advertisements is fine-tuned based at 655 on observed historical conversion rates of various advertisements in a variety of contexts (e.g., different articles and different chatbot interactions), such as by providing examples of advertisements having high conversion rates and their corresponding placements within content.

In a case where the advertiser has not approved previously generated advertisements, then at 657 the system determines whether to generate an advertisement based on an advertisement (e.g., advertisement text copy and/or images) provided by the advertiser, which may have been manually created by an advertising director (e.g., one or more humans). If so, then the advertiser's advertisement is provided as an input to the language model to generate advertisements at 655. If not, then the advertiser's advertisement is provided to be ranked as an advertisement at 661.

The process of generating advertisements at 655 and/or receiving advertisements from advertisers at 657 to be placed at one or more locations in the content is performed for a plurality of different advertisers to generate a plurality of different advertisements. As such, at 661 the advertisements generated at 655 or advertiser-provided advertisements from 657 for the different locations and for the plurality of different advertisers are ranked based on conversion probability. In some embodiments, the ranking is performed by a content ranking language model trained based on historical conversion rates of advertisements placed in a variety of contexts (e.g., the same training data used above to generate contextually consistent advertisements at different locations) to compute conversion probabilities of the different advertisement placements.

Accordingly, aspects of embodiments generate a highest-value (e.g., highest expected value) advertisement tailored for the user viewing the content 633 based on their user profile.

At 663, prices are determined for the highest-ranking advertisements. As noted above, the user mindset is determined based on the user profile 631 and the content of the article and therefore the price is determined at 663 based on the user profile. In addition, the content 633 is also a factor in determining the user mindset and therefore also affects the calculation of the price at 663. In some embodiments, a semantic distance between the advertisement and the content is explicitly considered when calculating a price at 663. For example, an advertisement may have a higher price when it is semantically closer to the content 633 (e.g., smaller semantic distance) than in cases where the advertisement is semantically different from the content 633.

In some embodiments, the advertiser profile created at 615 may further include information about the monetary value and/or other indication of an amount that the advertiser is willing to spend to convert a customer (e.g., sell an instance of the product). Examples of such indication of willingness to spend include a margin on a product (e.g., selling price minus cost to produce) and an advertising budget as allocated on a per-sale basis. Here, an advertiser may be willing to pay a higher price for an advertisement if the product being sold has a high margin (e.g., a vehicle or an ongoing subscription service) versus a low margin (e.g., a pair of socks).

The process of generating advertisements tailored for a given user profile 631 and given content 631 may be performed for a plurality of different advertisers, thereby generating a plurality of different advertisements. The different advertisers may have different bidding strategies informing different conditions and goals 607, as implemented by automated agents, as described above.

The automated agents provide bids at 609, and at 671 bids from advertisers with the highest rankings are accepted (e.g., highest bids). In some embodiments, the advertisers are considered in order of the ranking determined at 661 where the advertisement with highest conversion probability and/or highest price is considered first. When considering an advertisement, the bid from the corresponding advertiser is compared with the price calculated at 663. If the bid satisfies the price (e.g., if the bid is greater than or equal to the price) or if the price is consistent with the bidding strategy, then the bidder is considered to have won. The advertisement corresponding to the winning bidder (or advertisements corresponding to winning bidders) are placed at corresponding locations within the content at 673 (e.g., delivered by the supplemental content delivery server 510 to be inserted into a web page 512 by a script embedded in the web page 512).

In some embodiments of the present disclosure, the method 600 is performed in real-time, such as during loading of a web page containing an article or during generation of a chatbot response, such that the entire process in completed in less than 1 second (e.g., sub-second generation, auction, and placement of contextual advertisements that are tailored to the specific user).

The performance of the placed advertisements is, in some embodiments, tracked to collect training data for at least the advertisement placement language model and for the language model configured to compute conversion probabilities, as described above. Such training data may be included in prompts configuring the language models (e.g., as few-shot examples) and/or may be included in training data for fine-tuning the language models to improve performance (e.g., improve placements of advertisements within web pages or to increase accuracy of predictions of conversion probabilities).

In some embodiments of the present disclosure, the generated contextual advertisements are (or include) chatbots directly in the advertisement unit. There is a search/chat box where a user or viewer can ask follow-up questions or for more information, for example:
Where can I buy it?
How much does it cost?
Do you work with usb-c chargers?
What kind of guarantee do I get?
Tell me more about feature xyz

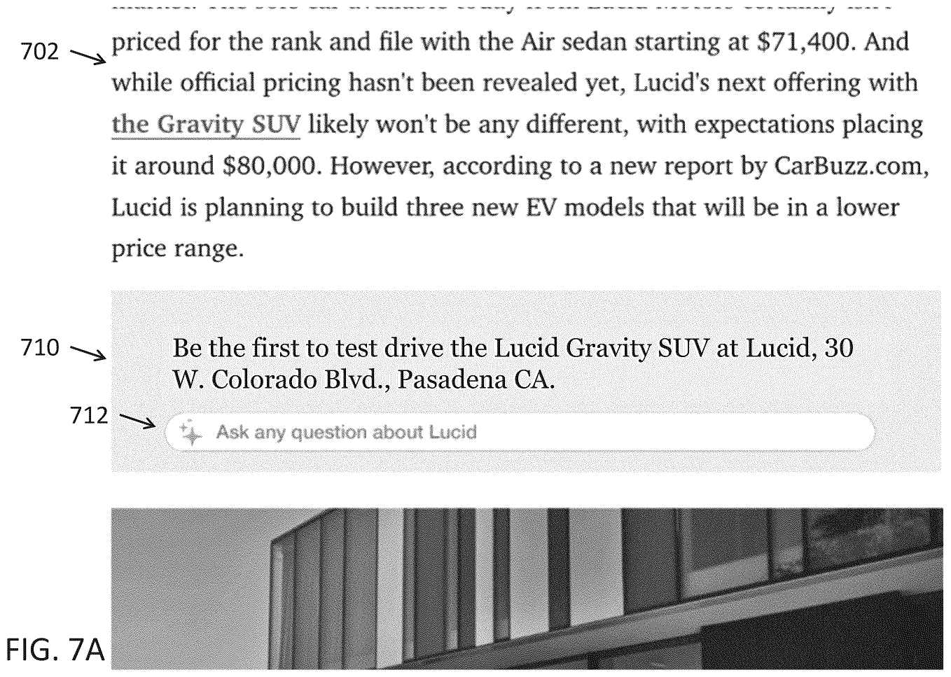

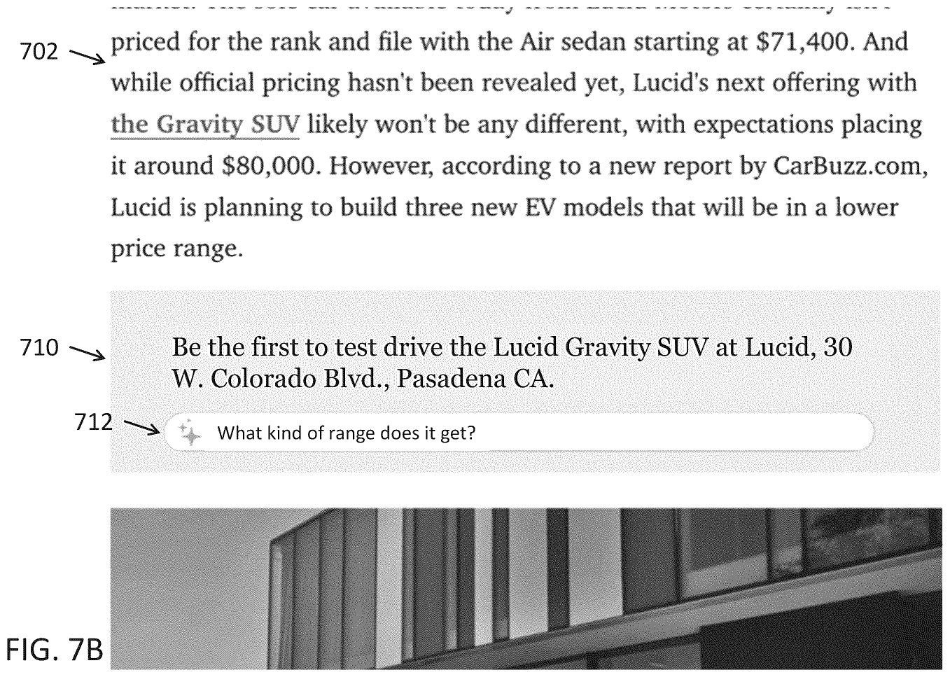

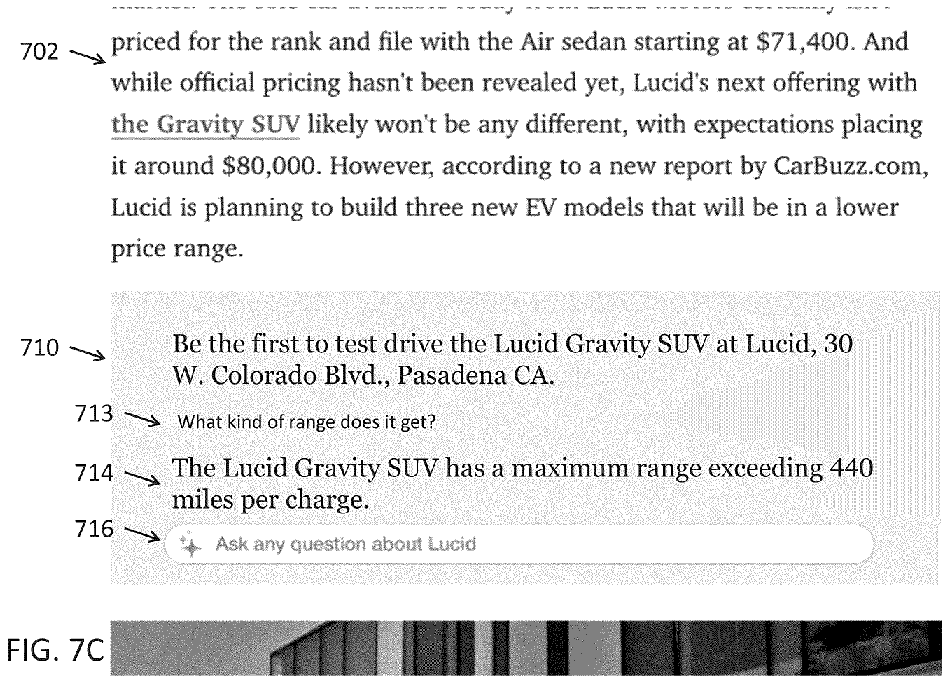

FIGS. 7A-7C illustrate an example of a chatbot advertisement 710 inserted into a news article 702 regarding electric vehicles, where the chatbot advertisement includes an interactive component 712 for a user to ask questions or otherwise start a conversation with a chatbot regarding the advertised product, according to one embodiment of the present disclosure. As shown in FIG. 7A, the chatbot advertisement unit 710 may show information about a product being advertised—here, information about where to test drive a specific model of an electric vehicle, where the advertisement is generated based on the context of the document (e.g., a news article about new models of electric vehicles to be released by a specific manufacturer) and based on user profile information (e.g., a geographic or physical location of the user is used to identify the location of the nearest showroom where the viewer or user can test drive the advertised model of the vehicle). The chatbot advertisement 710 further includes an interactive component 712, here in the form of a text input box or chat input box, but not limited thereto (e.g., in some embodiments, the interactive component 712 may request access to a hardware microphone so that the user can ask a question by speaking or may request access to a hardware camera so that a user can present a question by taking a picture or uploading an image).

In some embodiments, the interactive advertisement unit 710 uses large language model technology (or other generative artificial intelligence technology) to allow a user to query the advertiser and to receive a response in the advertisement unit 710 without the user leaving the page (or by leaving the page, to continue the conversation that started on the page). In some embodiments, the interactive advertisement unit 710 provides an interface to a chatbot language model.

In some embodiments, the interactive component 712 or chat input box is pre-filled with a suggested prompt or suggested question for the user to submit to the chatbot. The suggested prompt or suggested question may be shown in lighter-colored text. The interactive component 712 may also show a plurality of different suggested prompts or questions and the display of the interactive component 712 may cycle through these suggestions, where the user may accept a suggestion to supply to the chatbot, modify a suggestion, or may enter their own question.

In some embodiments, the suggestions are generated by prompting the chatbot to create a plurality of suggested questions. The prompt to the chatbot to create the questions may also include the user profile 631, the content 633, and/or the user mindset determined at 637, such that the questions are tailored to the user's interest and tailored to the context of the content 633. For example, the advertisement may relate to an electric SUV and the content 633 may be a review of a competing electric SUV. In such a case, the user profile 631 may include information about the user's specific interests based on prior browsing history (e.g., range of the electric vehicle, prior search history regarding children's sports equipment, and spaciousness of back seats and trunk), which may be used together with the content 633 of the review to automatically generate suggested questions such as “How does the ranges of these SUVs compare?” and “Which of these vehicles would be more comfortable for two adults and three teenagers and can carry a load of soccer gear?”

In FIG. 7B, a user has asked a question about the advertised vehicle: “What kind of range does it get?” The question presented by the user is provided to a large language model (LLM) (e.g., a chatbot language model) that has been prompted with information retrieved about the advertised product. In some embodiments, this information may be substantially the same information 451 that was previously retrieved from the advertiser's website for the purpose of generating the contextual advertisements for the products and/or information provided by the advertiser regarding the products. In some embodiments, retrieval augmented generation (RAG) is used by the chatbot language model to search a collection of information (e.g., the content index 473) to identify sections of the information that would be useful for generating a response (e.g., a list of specifications of the advertised vehicle or vehicles). In some embodiments, the chatbot language model is further prompted with the primary content of the context in which the advertisement unit 710 has been inserted, where the prompt further includes instructions to include supplemental content that is not present in the primary content. For example, in a case where the primary content may indicate the volume of the rear storage compartment only in cubic feet, the user may ask a question about the size of the trunk, and the chatbot language model would generate additional information regarding the size and shape of the trunk (e.g., dimensions in length, width, and height) beyond merely repeating the volume in cubic feet. As such, the chatbot language model is prompted to generate a response to the user's question, where the prompt includes information for generating an accurate response.

As shown in FIG. 7C, the chatbot language model provides a response 714 to the user's question 713, providing the estimated maximum range of the advertised vehicle. FIG. 7C further shows an interactive component 716 for the user to continue the conversation with the chatbot to ask further questions about the vehicle or its manufacturer. Further questions from a user may be responded to by a chatbot language model that is prompted with the same background information regarding the advertised product and/or advertiser, along with the chat history of interactions between the user and the chatbot.

Some aspects of embodiments of the present disclosure relate to further refining or re-computing an inferred purchase intent based on user inputs to the interactive advertisement unit 710. For example, in some embodiments, the chat interaction between the user and the chatbot (e.g., the. user's questions and the responses generated by the LLM) are supplied as additional context to the language model that is configured (e.g., prompted and/or fine-tuned) to infer the user's purchase intent, thereby generating a purchase intent score (e.g., a value from 0% to 100%) and/or a purchase intent category. In some embodiments, the computed inferred purchase intent is further included in the prompt used by the chatbot in generating responses to user queries. In some embodiments, the computed inferred purchase intent is used in setting a price of the advertisement (e.g., the amount paid if the user clicks on the advertisement to visit the advertiser's website).

While FIGS. 7A, 7B, and 7C show an example of a chatbot interaction in the case where the supplemental content is an advertisement, embodiments of the present disclosure are not limited thereto. For example, in some embodiments the supplemental content includes definitions or explanations of technical terminology used in the primary content. In the example shown in FIG. 7A, the primary content may mention the type of electric vehicle charging connecter used by the specific electric vehicle described in the primary content without defining the standard. As such, a chatbot LLM may be prompted with information relevant to the landscape of electric vehicles, including the different electric vehicle charging connectors available on the market, and a user may then ask questions about cross-compatibility between electric vehicle chargers, the extensiveness of the electric vehicle charging network implementing that standard, and the like.

Some aspects of embodiments of the present disclosure further relate to placing an advertisement from a specific advertiser chosen from among a plurality of advertisers based on the context (e.g., the content of a web page and information about a user viewing the web page) that the advertisement will be placed into. In some embodiments, a trained language model (e.g., a fine-tuned language model) is prompted to select the subject matter of the advertisement (e.g., a prompt such as: “given the following primary content and user profile, select an advertisement from one of the following advertisements, then regenerate the advertisement to match the style of the page content. Select the advertisement that will have the highest value for the advertiser, based on click through rate, conversion rate, and product value. Here is the page content: {primary_content}. Here is the user profile: {user_profile]. Here are the advertisements: {advertisements}”), where the language model may also generate the content of the advertisement. In some embodiments the language model is further configured or prompted to identify a location to place the advertisement within the content (e.g., within an article or chatbot response with a prompt such as: “given the following primary content, user profile, and advertisement, select a location within the primary content to place the advertisement that is expected to have the highest click through rate.”).

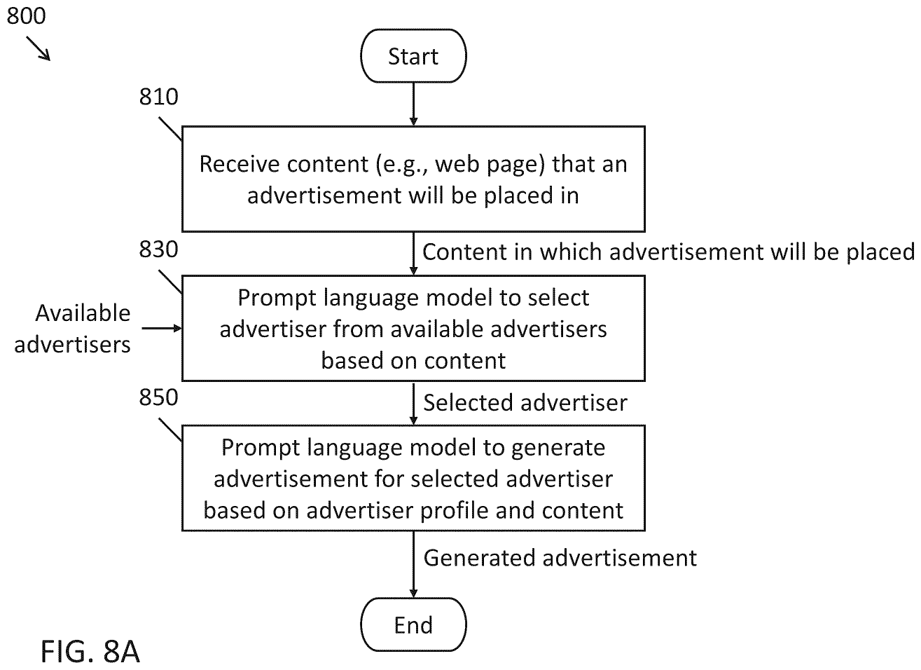

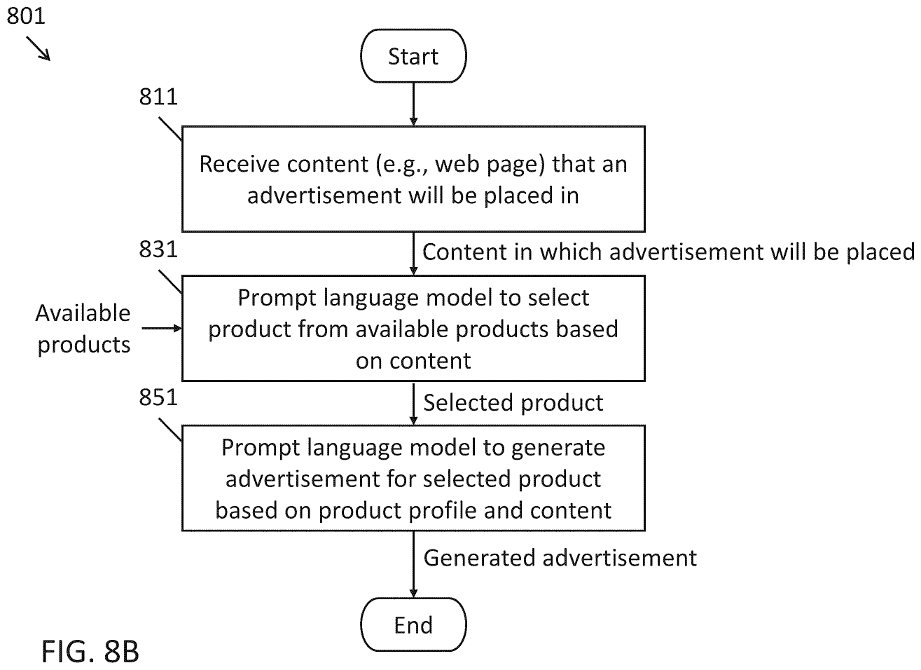

FIG. 8A is a flowchart of a method 800 for generating and placing an advertisement in the context of a web page, such as an article or chatbot response, where an advertiser is selected from a plurality of advertisers based on the context of the web page, according to one embodiment of the present disclosure. The method may be implemented by a computer system including a processor and memory, where the memory may store the language model (e.g., trained parameters such as weights and biases of the trained neural network that implement the language model) and wherein the processor (e.g., a central processing unit, a graphics processing unit, a neural accelerator, or the like) perform feedforward inference using the trained parameters the language model to compute an output. Such a computer system may be a component of an advertisement generation system 430 or 530. For example, in some embodiments, the method 800 may be implemented by portions of the ad selection and ad generation component 537 and the advertisement placement recommendation component 535 described above with respect to FIG. 5.

At 810, the advertisement generation system receives content (e.g., a web page) that an advertisement will be placed into, such as at 503 of FIG. 5. At 830, a language model is prompted to select an advertiser from a plurality of available advertisers, where the advertiser is selected based on the received content. The provided collection of advertisers (e.g., list of advertisers) may be a list of advertisers that are registered or enrolled with the advertisement generation system, such as advertisers who have signed up to have advertisements generated and placed in a semantically and contextually aware manner as described above.

At 830, a supplemental source selection language model (e.g., an advertiser selection language model) selects a supplemental source (e.g., an advertiser) based on the content (e.g., the web page) and the available supplemental sources (e.g., advertisers). As one example, the advertiser selection language model is an instruction-tuned language model that is provided with the following prompt:

>>> Here is the page content:
<page content here>

### STEP: 1

Given the page_context, select a fitting commercial brand called selected_brand that would be relevant to the page_context.
Here are the brands with their urls:
{
“name”: “Brand A”,
“url”: https://exampleA.com
   },
   {
“name”: “Brand B”,
“url”: https://exampleB.com
   },
   . . .

While not shown above, in some embodiments the prompt further includes other aspects of the page_context, such as a profile of the user (e.g., at 631 of FIG. 6) and/or user mindset (637 of FIG. 6) determined based on user behavior and the content.

As one specific example, the content may be an article about the author Ian Fleming, and the list of advertisers may include BMW®, Omega® watches, Amazon. com®, and Orange Theory® Fitness. Here, the language model may generate text explaining a choice of Omega® watches based on the association between Ian Fleming and the character James Bond, the connection between James Bond with concepts of luxury and sophistication, and Omega® being the official watch worn by the James Bond character in numerous films.

At 850, the language model is prompted to generate an advertisement for the selected advertiser based on the advertiser profile and the content (e.g., the web page). As one example, an instruction-tuned language model may be provided with the following prompt:

### Table 2

### STEP: 2

You are the author of the page_context, write the advertisement_copy below to be the most engaging advertisement for the selected product. Return just the result in well-formed XML, without comments and explain the choice of brand and the advertisement copy.

### Output Example:

<result>
<advertisement_copy>advertisement_copy</advertisement_copy>
<selected_brand>selected_brand</selected_brand>
<selected_brand_url>selected_brand_url</selected_brand_url>
</result>

In some embodiments, the steps at 830 and 850 are performed together by prompting the language model once to both select the advertiser based on the context (e.g., the content and user profile) and proceed with generating an advertisement and a location for that advertisement within the content.

The generated advertisement (e.g., advertisement_copy) may then be returned to be inserted into the content (e.g., delivered to a web browser by the advertisement delivery server 510 and inserted into the web page using the script).

A similar approach may be applied at the level of specific products rather than brands or advertisers. For example, the language model may be prompted with a plurality of products to be advertised in a semantically and contextually aware manner, and the language model selects a product. FIG. 8B is a flowchart of a method 801 for generating and placing an advertisement in the context of a web page, such as an article or chatbot response, where an advertiser is selected from a plurality of advertisers based on the context of the web page, according to one embodiment of the present disclosure. The operations in FIG. 8B are substantially the same as those of FIG. 8A, except that the language model selects between different products rather than different advertisers.

As a specific example, the same content regarding author Ian Fleming may be received at 811, but at 831 the language model is prompted to select from several different products, such as: microfiber towels for cars; a streaming media device; and a portable guitar amplifier. The language model may similarly generate an advertisement for the selected product at 851 and may also provide an explanation for the selection. In this example, the language model may select the streaming media device based on the connection between Ian Fleming, the James Bond character, and the ability to watch the associated James Bond movie franchise using the streaming media device.

Accordingly, aspects of embodiments of the present disclosure relate to systems and methods for automatically generating supplemental content such as advertisements, fact checking sidebars, and definitions of technical language in a manner that is semantically and contextually aware of the surrounding content. These embodiments of the present disclosure enables the subject matter of the advertisements to have high relevance to the surrounding content, allows advertisers improved control over what topics the brand is associated with (e.g., by requesting that their advertisements not be shown alongside content relating to specific topics), and enables the advertisement itself to be automatically rewritten (e.g., using a language model) to match the style of the surrounding content. Embodiments of the present disclosure further automatically generate content that increases user engagement, in contrast to more generic links to other web pages that the user “might be interested in” after consuming the primary content of the web page.

It should be understood that the sequence of steps of the processes described herein in regard to various methods and with respect various flowcharts is not fixed, but can be modified, changed in order, performed differently, performed sequentially, concurrently, or simultaneously, or altered into any desired order consistent with dependencies between steps of the processes, as recognized by a person of skill in the art. Further, as used herein and in the claims, the phrase “at least one of element A, element B, or element C” is intended to convey any of: element A, element B, element C, elements A and B, elements A and C, elements B and C, and elements A, B, and C.

The term non-transitory computer-readable medium is to be understood herein to refer to one or more non-transitory computer-readable media, such as a single solid-state drive, multiple solid-state drives connected in a redundant array of independent drives, one or more hard disk drives (e.g., magnetic data storage media), one or more optical (e.g., CD-ROM or DVD-ROM) media, one or more pools of data storage devices connected to one or more computer servers, and the like.

According to one embodiment of the present disclosure, a method using language models for automatically generating supplemental content for placement in primary content presented to a user, includes: providing identification information for a provider of supplemental content; retrieving information on the provider of supplemental content from the internet using the identification information to generate a content source profile; retrieving a user profile about the user; computing, with a user mindset prediction language model configured to determine a user's mindset while reviewing content, the user's mindset based on the primary content presented to the user; selecting, by a supplemental source selection language model configured to select supplemental sources, the provider of supplemental content from a plurality of supplemental sources, based on the primary content; and generating in real-time, with a supplemental content generation language model configured to generate supplemental content, one or more pieces of supplemental content for the provider of supplemental content at one or more locations that are contextually consistent with the primary content.

The method may further include providing a chat input box for the user to interactively communicate with a chat language model configured based on the information on the provider of supplemental content to obtain information about the supplemental content or the provider of the supplemental content.

The method may further include generating, in real time, one or more contextually consistent prompts within the chat input box for the user to choose about the supplemental content or the provider of the supplemental content.

The profile of the user maybe provided as an input for generating the one or more contextually consistent prompts.

The method may further include using a language model to determine the context of the primary content and a user's purchase intent from the user's mindset while viewing the primary content.

The method may further include determining a score of the purchase intent or a category of the purchase intent.

The step of generating the supplemental content may further using the language model to progressively produce the contextually consistent supplemental content based on the context of the primary content, and the user's profile or the user's mindset.

The supplemental content may include an advertisement, and the method may further include generating a price for the advertisement at least partially based on the user's profile or the user's mindset; extracting, by a bidding strategy language model, a plurality of goals from a bidding strategy including text describing goals of the provider of supplemental content; and configuring a bidding agent language model for the provider of supplemental content based on the plurality of goals to implement an automated agent to generate a bid for the advertisement based on the plurality of conversion goals.

The method may further include setting the price at least partially based on the user's demographics, age, sex, education, interests, search history or geographic location obtained from the user's profile.

The method may further include determining a level of contextual match for the advertisement to the primary content and generating the price at least partially based on the contextual match, wherein the higher the contextual match the higher the price of the advertisements.

The method may further include determining a monetary value of an item displayed in the advertisement, wherein the higher the monetary value of the item the higher the price for the advertisement.

The method may further include determining a ranking for the advertisement based on the price of the advertisement or the contextual match of the advertisement to the primary content.

The method may further include generating in real time a highest-ranking value advertisement to the user viewing the primary content.

The supplemental content may be multimodal including images, music, movies, or text, and the method may include generating, with the language model, the multimodal supplemental content contextually relevant to the primary content, user's mindset or the user's profile.

The supplemental content may include an advertisement and the provider of supplemental content is an advertiser, the method may further include: providing a chat input box for the user to interactively communicate with a chat language model configured based on the information on the advertiser to obtain information about the advertisement or advertiser; and determining a purchase intent of the user based on a query provided to the chat input box and the chat language model, wherein the higher the purchase intent the higher a price of the advertisement.

The supplemental content may include an advertisement and the provider of supplemental content is an advertiser, the method may further include determining in real time, by a contextual placement language model configured to place an advertisement within content, the one or more locations in the primary content that contextually fit: a) the profile of the of the advertiser; b) the user's mindset; or c) the profile of the user.

The method may further include recording user activity associated with versions of a plurality of advertisements at the one or more locations in the primary content, and using the recorded user activity as feedback to the language model to improve conversion goals of the advertiser for the advertisements.

The supplemental content may include an advertisement and the provider of supplemental content may be an advertiser, the method may further include determining a contextual match of the advertisement with the primary content to determine a pricing of the advertisement, the higher the contextual match the higher a price of the advertisement for the advertiser, wherein computing the contextual match includes computing a cosine distance between vector embeddings of the advertisement and the primary content.

The primary content may include at least one of: a website; a chatbot interaction; a software application; a video, an audio program, or music.

The supplemental content may include an advertisement and the provider of supplemental content may be an advertiser, wherein the information about the provider of the supplemental source may further include one or more of the advertiser's websites, reviews, products, services, customers or competition.

The supplemental content may include an advertisement and the provider of supplemental content may be an advertiser, wherein the step of generating the supplemental content may further include progressively producing the contextually consistent advertisements based on the user profile.

According to one embodiment of the present disclosure, a method for using language models to automatically generate contextual supplemental content with a chat input box for placement in primary content presented to a user, includes: providing identification information for a provider of supplemental content, retrieving information on the provider of the supplemental content from the internet using the identification information to generate a content source profile, obtaining user profile information about the user, selecting, by a supplemental source selection language model configured to select supplemental sources, the provider of supplemental content from a plurality of supplemental sources based on the primary content and the user profile information, generating in real-time, with a supplemental content generation language model, contextually consistent supplemental content to the primary content at a plurality of contextual locations within the primary content, and providing the chat input box to enable the user to interactively communicate with a chatbot language model to obtain information about the advertisement, the chat input box located at a location within the primary content.

The step of generating the supplemental content may further include progressively producing the contextually consistent supplemental content based on the user profile.

The supplemental content may be multimodal and may include images, music, movies, or text, and the step of generating the supplemental content in real-time to be contextually relevant to the primary content and the user's profile and matching the tone, flow and style of the primary content.

The supplemental content may include an advertisement, and the generated advertisement may exceed a threshold of a contextual match between the generated advertisement and the primary content, the higher the contextual match the higher a price of the advertisements to the advertiser.

The method may further include determining, by a language model, a purchase intent of the user from a query received through the chat input box, and generating prompts for the user to choose based on the user's purchase intent.

The method may further include determining the contextual match of the advertisement with the primary content to determine the pricing of the advertisement, wherein the higher the contextual match the higher a price of the advertisement for the advertiser.

The method may further include determining in real-time, with a contextual placement language model configured to select a location of an advertisement in a context, one or more of locations in the primary content that contextually fit the profile of the advertiser and the profile of the user, the one or more locations including the location of the chat input box within the primary content.

The method may further include recording user activity associated with versions of the advertisements at the content locations, and using the recorded activity to train the placement language model to improve the effectiveness of the versions of the advertisements.

The primary content may include a website, an application, a TV ad, a radio announcement, or music.

The information about the advertiser may further one or more of the advertiser's websites, reviews, products, or competition.

According to one embodiment of the present disclosure, a method using language models for automatically generating advertisements for placement in primary content presented to a user, includes: providing identification information for a plurality of advertisers; retrieving information on the advertisers from the internet using the identification information of the advertisers to generate a plurality of advertiser profiles; retrieving a user profile about the user; computing, with a user mindset prediction language model configured to determine a user's mindset while reviewing content, the user's mindset based on the primary content presented to the user; determining in real time, with a contextual placement language model configured to identify locations in content to insert advertisements, one or more locations in the primary content that contextually fit a) the user's mindset, or b) the profile of the user; generating in real-time, with a supplemental content generation language model, a plurality of contextually consistent advertisements for the plurality of advertisers at the one or more determined locations based on the advertiser profiles; ranking in real time, with a content ranking language model, the plurality of advertisements by their conversion probability at least partially based on the contextual fit of a) the user's mindset, or b) the profile of the user with the advertisement; and inserting the highest-ranking advertisement at the one or more determined locations within the primary content.

The method may further include determining a contextual match for the advertisements to the primary content and ranking the plurality of advertisements at least partially based on the contextual match, wherein the greater the contextual match the higher the rankings for the advertisements.

The method may further include determining the ranking for the advertisements based on a price of the advertisement and the contextual match of the advertisement to the primary content.

The method may further include determining the price for the advertisement at least partially based on the user's profile or the user's mindset.

The method may further include setting the price at least partially based on the user's demographics, age, sex, education, interests, search history or geographic location obtained from the user's profile.

The method may further include determining a monetary value of an item displayed in the advertisements, wherein the higher the monetary value of the item the higher the price for the advertisement.

The method may further include, for each of the plurality of advertisers, extracting, by a bidding strategy language model, a plurality of conversion goals from a bidding strategy comprising text describing goals of the advertiser; providing the plurality of conversion goals to a bidding agent language model for the advertiser to implement an automated agent to generate bids for placing advertisements in contexts based on the plurality of conversion goals.

The bidding strategy for the advertiser may include a budget of the advertiser for the generated advertisements.

The conversion goals may include a threshold minimum contextual match.

The method may further include accepting in real time a bid of the advertiser for the highest-ranking advertisement and generating the highest-ranking advertisement within the primary content.

According to one embodiment of the present disclosure, a method for using a language model to generate advertisements in real time and choose one for placement in primary content presented to a user, includes: providing, to a computer system, identification information for a plurality of advertisers; retrieving information on the advertisers from the internet using the identification information of the advertisers to generate a plurality of advertiser profiles; for each of the plurality of advertisers, providing a prompt to a bidding agent language model for the advertiser to provide a bidding strategy; retrieving a user profile about the user; computing, with a user mindset prediction language model configured to determine a user's mindset while reviewing content, the user's mindset based on the primary content presented to the user; and performing, by the computer system in real time the following steps: determining, with a contextual placement language model, one or more locations in the primary content that contextually fit the user's mindset; generating, with the language model, a contextually consistent advertisement for each of the plurality of advertisers at the one or more determined locations based on the advertiser profiles; ranking, with the language model, the plurality of advertisements by their conversion probability at least partially based on the contextual fit of the user's mindset; determining, with the language model, at least one highest ranking advertisement that matches the bidding strategy of an advertiser; and generating, with the language model, within the primary content the highest-ranking advertisement at the one or more determined locations.

The bidding strategy may further include a price an advertiser is willing pay to obtain a conversion probability at least partially based on the contextual fit of the user's mindset.

The method may further include determining a contextual match for the advertisement to the primary content and ranking the plurality of advertisements at least partially based on the contextual match, wherein the higher the contextual match the higher the rankings for the advertisements.

The method may further include determining the ranking for the advertisements based on the price of the advertisement and the contextual match of the advertisement to the primary content.

The method may further include determining the price for the advertisement at least partially based on the user's profile or the user's mindset.

The method may further include setting the price at least partially based on the user's demographics, age, sex, education, interests, search history or geographic location obtained from the user's profile.

The method may further include determining a monetary value of an item displayed in the advertisements, wherein the higher the monetary value of the item the higher the price for the advertisement.

The bidding strategy for the advertiser may include the advertiser's conversion goals and the advertiser's pricing budget for the generated advertisements.

The conversion goals may include a threshold minimum contextual match.

The method may further include accepting in real time the advertiser's bid for the highest-ranking advertisement and generating the highest-ranking advertisement within the primary content.

Embodiments of the present disclosure may be implemented with one or more computer systems, where a computer system may include one or more processors and one or more computer-readable memories. The memories of the computer system store instructions that configure the computer system to implement special-purpose devices such that, when the instructions are executed by the one or more processors, the computer systems implement aspects of the embodiments of the present disclosure. As one example, the computer system may be a cloud-based computer system implementation, where the cloud-based computer system may include a hosted computing environment that includes a collection of physical computing resources that are remotely accessible, located at different facilities, and may be rapidly provisioned as needed. Certain data described herein may optionally be stored using a data store that may include a hosted storage environment that includes a collection of physical data storage devices that may be remotely accessible and may be rapidly provisioned as needed.

Embodiments of the present disclosure may also be implemented as instructions stored on a non-transitory computer-readable medium and/or non-transitory computer-readable media. The instructions, when executed by a computer system (e.g., one or more processors of the computer system) configure the computer system to implement special purpose devices and systems to perform the methods described above.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner.

What is claimed is:

1. A method using language models for automatically generating supplemental content for placement in primary content presented to a user, comprising:
providing identification information for a provider of supplemental content;
retrieving information on the provider of supplemental content from the internet using the identification information to generate a content source profile;
retrieving a user profile about the user;
computing, with a user mindset prediction language model configured to determine a user's mindset while reviewing content, the user's mindset based on the primary content presented to the user;
selecting, by a supplemental source selection language model configured to select supplemental sources, the provider of supplemental content from a plurality of supplemental sources, based on the primary content; and
generating in real-time, with a supplemental content generation language model configured to generate supplemental content, one or more pieces of supplemental content for the provider of supplemental content at one or more locations that are contextually consistent with the primary content.

2. The method of claim 1, further comprising providing a chat input box for the user to interactively communicate with a chat language model configured based on the information on the provider of supplemental content to obtain information about the supplemental content or the provider of the supplemental content.

3. The method of claim 2, further comprising generating, in real time, one or more contextually consistent prompts within the chat input box for the user to choose about the supplemental content or the provider of the supplemental content.

4. The method of claim 3, wherein the profile of the user is provided as an input for generating the one or more contextually consistent prompts.

5. The method of claim 1, further comprising using a language model to determine the context of the primary content and a user's purchase intent from the user's mindset while viewing the primary content.

6. The method of claim 5, further comprising determining a score of the purchase intent or a category of the purchase intent.

7. The method of claim 1, wherein the step of generating the supplemental content further comprises using the language model to progressively produce the contextually consistent supplemental content based on the context of the primary content, and the user's profile or the user's mindset.

8. The method of claim 7, wherein the supplemental content comprises an advertisement, and
wherein the method further comprises:
generating a price for the advertisement at least partially based on the user's profile or the user's mindset;
extracting, by a bidding strategy language model, a plurality of goals from a bidding strategy comprising text describing goals of the provider of supplemental content; and
configuring a bidding agent language model for the provider of supplemental content based on the plurality of goals to implement an automated agent to generate a bid for the advertisement based on the plurality of conversion goals.

9. The method of claim 8, further comprising setting the price at least partially based on the user's demographics, age, sex, education, interests, search history or geographic location obtained from the user's profile.

10. The method of claim 8, further comprising determining a level of contextual match for the advertisement to the primary content and generating the price at least partially based on the contextual match, wherein the higher the contextual match the higher the price of the advertisements.

11. The method of claim 10, further comprising determining a monetary value of an item displayed in the advertisement, wherein the higher the monetary value of the item the higher the price for the advertisement.

12. The method of claim 11, further comprising determining a ranking for the advertisement based on the price of the advertisement or the contextual match of the advertisement to the primary content.

13. The method of claim 12, further comprising generating in real time a highest-ranking value advertisement to the user viewing the primary content.

14. The method of claim 1, wherein the supplemental content is multimodal comprising images, music, movies, or text, and
wherein the method comprises generating, with the language model, the multimodal supplemental content contextually relevant to the primary content, user's mindset or the user's profile.

15. The method of claim 1, wherein the supplemental content comprises an advertisement and the provider of supplemental content is an advertiser,
the method further comprising:
providing a chat input box for the user to interactively communicate with a chat language model configured based on the information on the advertiser to obtain information about the advertisement or advertiser; and
determining a purchase intent of the user based on a query provided to the chat input box and the chat language model, wherein the higher the purchase intent the higher a price of the advertisement.

16. The method of claim 1, wherein the supplemental content comprises an advertisement and the provider of supplemental content is an advertiser,
the method further comprising determining in real time, by a contextual placement language model configured to place an advertisement within content, the one or more locations in the primary content that contextually fit: a) the profile of the of the advertiser; b) the user's mindset; or c) the profile of the user.

17. The method of claim 16, further comprising recording user activity associated with versions of a plurality of advertisements at the one or more locations in the primary content, and using the recorded user activity as feedback to the language model to improve conversion goals of the advertiser for the advertisements.

18. The method of claim 1, wherein the supplemental content comprises an advertisement and the provider of supplemental content is an advertiser,
the method further comprising determining a contextual match of the advertisement with the primary content to determine a pricing of the advertisement, the higher the contextual match the higher a price of the advertisement for the advertiser, wherein computing the contextual match comprises computing a cosine distance between vector embeddings of the advertisement and the primary content.

19. The method of claim 1, wherein the primary content comprises at least one of: a website; a chatbot interaction; a software application; a video, an audio program, or music.

20. The method of claim 1, wherein the supplemental content comprises an advertisement and the provider of supplemental content is an advertiser,
wherein the information about the provider of the supplemental source further comprises one or more of the advertiser's websites, reviews, products, services, customers or competition.

21. The method of claim 1, wherein the supplemental content comprises an advertisement and the provider of supplemental content is an advertiser,
wherein the step of generating the supplemental content further comprises progressively producing the contextually consistent advertisements based on the user profile.

22. A method for using language models to automatically generate contextual supplemental content with a chat input box for placement in primary content presented to a user, comprising:
providing identification information for a provider of supplemental content,
retrieving information on the provider of the supplemental content from the internet using the identification information to generate a content source profile,
obtaining user profile information about the user,
selecting, by a supplemental source selection language model configured to select supplemental sources, the provider of supplemental content from a plurality of supplemental sources based on the primary content and the user profile information,
generating in real-time, with a supplemental content generation language model, contextually consistent supplemental content to the primary content at a plurality of contextual locations within the primary content, and
providing the chat input box to enable the user to interactively communicate with a chatbot language model to obtain information about the advertisement, the chat input box located at a location within the primary content.

23. The method of claim 22, wherein the step of generating the supplemental content further comprises progressively producing the contextually consistent supplemental content based on the user profile.

24. The method of claim 23, wherein the supplemental content is multimodal and comprises images, music, movies, or text, and the step of generating the supplemental content in real-time to be contextually relevant to the primary content and the user's profile and matching the tone, flow and style of the primary content.

25. The method of claim 22, wherein the supplemental content comprises an advertisement, and
wherein the generated advertisement exceeds a threshold of a contextual match between the generated advertisement and the primary content, the higher the contextual match the higher a price of the advertisements to the advertiser.

26. The method of claim 25, further comprising determining, by a language model, a purchase intent of the user from a query received through the chat input box, and generating prompts for the user to choose based on the user's purchase intent.

27. The method of claim 26, further comprising determining the contextual match of the advertisement with the primary content to determine the pricing of the advertisement, wherein the higher the contextual match the higher a price of the advertisement for the advertiser.

28. The method of claim 27, further comprising determining in real-time, with a contextual placement language model configured to select a location of an advertisement in a context, one or more of locations in the primary content that contextually fit the profile of the advertiser and the profile of the user, the one or more locations comprising the location of the chat input box within the primary content.

29. The method of claim 28, further comprising recording user activity associated with versions of the advertisements at the content locations, and using the recorded activity to train the placement language model to improve the effectiveness of the versions of the advertisements.

30. The method of claim 22, wherein the primary content comprises a website, an application, a TV ad, a radio announcement, or music.

31. The method of claim 22, wherein the information about the advertiser further comprises one or more of the advertiser's websites, reviews, products, or competition.
